(19) United States
(12) Patent Application Publication
(10) Pub. No.: US 2005/0205545 A1
(43) Pub. Date: Sep. 22, 2005

(54) Bench top grill

(76) Inventors: Dan Siegel, Huntington, NY (US); John Shilkin, New York, NY (US)

Correspondence Address: PERRY TEITELBAUM, ESQ.;GOODMAN & TEITELBAUM, ESQS., Suite 1400, 26 Court Street, Brooklyn, NY, 11242, US

(21) Appl. No.: 10/804,565

(22) Filed: Mar. 19, 2004

(51) Int. Cl. F27D 11/00; H05B 3/06

(52) U.S. Cl. 219/386; 219/521; 219/438

(57) ABSTRACT

An bench top grill includes at least one grilling element proximate a grilling zone bounded on at least two sides, a user safety mechanism, and an easily cleaned and maintained aesthetic design. At least one guard member proximate the grilling element provides a safe grilling position in a grilling zone. A utensil rest, optionally integrated with the user safety mechanism, supports a user's utensil and enables a guided grilling of a food item in the grilling zone during use.

### BACKGROUND OF THE INVENTION

1. Field of the Invention

The present invention relates to grills. More specifically, the present invention relates to a bench top grill with at least one electric grilling element proximate a grilling zone, an improved safety switch, and a configuration that enables the grill to be easily cleaned and maintained.

2. Description of the Related Art

Many conventional types of grills exist. Most conventional grills are suitable for only outdoor grilling and require the use of an external fuel source such as wood, barbeque chips, or sterno/petroleum-type fuels. Common conventional grills employ a horizontal grilling surface supporting the items to be grilled positioned above a heat source. One common example of this type of conventional grill is the Webber® One Touch® Grill.

Grilling food items is growing in popularity for several reasons. Grilling food avoids the use of deleterious cooking oils or breaded coverings. Removing cooking oils and breading increases the nutritional value of the item grilled grilling. Grilling is often significantly faster than conventional baking and frying because the heat source directly impinges upon the item to be grilled. Further, while frying and baking are often cramped kitchen-focused activities, grilling is enjoyable in out-of-doors locations is often associated with an open flame, i.e. burning charcoal or wood. Consequently, grilling may brings a nostalgic pleasure to the grilling process often lacking in more mundane modes of cooking.

Unfortunately, the benefits of open flame grilling are often unavailable in a home or at a restaurant table. Consequently, the present assignee has invented a portable Bench Top Grill employing a heating unit bounded in a portable grill body, described in U.S. Ser. No. 10/428,621. A removable grill is supported above the heating unit. The Bench Top Grill allows a user to grill items either directly on the grill, or having removed the grill, over the open flame-type heating unit. In this manner, the invention enables an indoor grilling operation in a safe and convenient manner. It is envisioned that common items to be grilled with the grill of U.S. Ser. No. 10/428,621 (and other grills) includes meats (steak, chicken, fish, shrimp etc), fruits and vegetables (pepper, squash, corn, apples, pineapple etc.), and snack foods (marshmallows, breads, s'mores etc.)

Other conventional grills are designed for indoor counter-top use and employ some form of grilling top assembly, often a horizontal surface, a grill supporting framework, and some type of heat source, for example an electric or gas stove burner grill or a secured sterno-type burner with a grilling pan positioned above the sterno can. Again, in this type of conventional configuration the item to be grilled is positioned on the grilling top assembly over the heat source. One common example of an indoor conventional grill is the George Forman® grill with the slanted grilling surface to drain cooking oils and fats.

Unfortunately, it is often difficult for grilled items to receive a uniform grilling energy from a single (unidirectional) heat source, positioned below the item-to-be-grilled. Nonuniform grilling may result in both burned and under cooked zones on the same item, causing frustration and raising health concerns.

As an additional detriment to most conventional grilling units, there is no immediate safety switch, to cease the grilling action upon the release of switch, catch, timer, or other action. Since many grilling designs employ flames, the combustion must be stopped for safety, making the use of an automatic safety switch impossible.

Conventional grills also attempt to provide a common planar grilling or symmetrical grilling temperature across the entire planar grilling or heating surface, in an attempt to generate grilling uniformity. Unfortunately, conventional unidirectional grilling energy necessarily produces asymmetric (non-uniform) grilling temperature ranges and hence grilling results. Additionally, conventional grill designs prevent the development of intentionally thermally-focused areas employable by a user to reduce a grilling time and maximize a grilling rate in a grill.

Finally, due to the conventional vertically-oriented grill path (e.g. food item —over a grill grate—over a heat source) cooking oils, grease, and fluid drippings often land directly on the grill grate and the heat source, making simple clean up difficult or impossible and creating a fire hazard.

In sum, the disadvantages of the known grilling mechanism generally include:

1. Unidirectional grilling energy producing asymmetric grilling results.

2. Grilling position below an item receives grilling-detritus from the items being grilled, making clean-up difficult and risking damage to the grilling and heating elements themselves.

3. Use of open flame or burning elements increases temperatures dangerously and produces combustion gasses prohibiting convenient indoor use.

4. No safety cut-off switch for rapid cessation the grilling process and placing thermal elements in an off-state or an on-state.

5. Lack of thermal focus increases grilling time and slows a grilling rate.

### OBJECTS AND SUMMARY OF THE INVENTION

It is an object of the present invention to provide a bench top grill that overcomes at least one of the detriments noted in the related art.

It is another object of the present invention to provide a grill with bi-directional grilling energy relative to defined grilling zone.

It is another object of the present invention to provide a bench top grill with a design enabling convenient positioning of at least one of a utensil and a utensil rest, with the utensil rest (and optionally a grill safety/reset switch) integrated with the grilling unit.

It is another object of the present invention to provide a bench top grill easily cleaned after use where grilled items cannot drip on a grilling heat source minimizing dripping fires.

It is another object of the present invention to provide a device enabling simple dishwasher clean up for at least a portion of the device, for example the utensil rest or a grill grate.

The present invention relates to a bench top grill including at least one grilling element proximate a grilling zone bounded on at least two sides, an improved user safety mechanism, and an aesthetic design that can be easily cleaned and maintained. At least one grill grate proximate a grilling element provides a safe grilling position in the grilling zone. An easily cleaned dripping-catch surface (at least a smooth surface, or possibly a non-stick, chromed, or stainless surface) below a grilling zone improves user convenience, rapid clean-up after use, and does not interfere with grilling. A utensil rest, optionally integrated with the user safety switch, supports a user's utensil and enables at least one of a guided and a supported grilling of a food item in the grilling zone during use. The present invention may optionally include a focused heat/grilling area within the grilling zone enabling a user to focus thermal energy on an item to be grilled. A dripping pan or removable dripping-catch pan may be alternatively positioned on the drip-catch surface below the grilling zone to receive dripping oils or dropped grilled items for easy cleaning.

According to another embodiment of the present invention, there is provided a bench top grill comprising: a main body unit defining at least a first grilling channel, at least two surfaces bounding the grilling channel, at least two of the at least two surfaces opposing each other, at least two heating elements proximate respective the at least two bounding surfaces providing a grilling thermal energy inwardly to the at least first grilling channel during a use, means for providing a lateral access to the grilling surfaces so that an item to be grilled can be introduced through one lateral end to be positioned proximate the heating elements, means for detecting an insertion of an items to be to be grilled into the grilling channel and for detecting a removal of the item from the grilling channel, and the means for detecting including means for actuating at least one of the heating elements upon a detection of the insertion of the item to be grilled thereby enabling the item to be grilled, and for deactivating the at least one of the heating elements upon the removal of the item from the grilling channel thereby providing a safe deactivation of the bench top grill.

According to an embodiment of the present invention there is provided a bench top grill, comprising: a main body unit including at least a first grilling channel, the grilling channel bounded on at least three sides by the main body unit, at least a first and an opposing second vertical side in the grilling channel relative to an external main body unit support surface, a first and a second heating element proximate respective vertical sides, each of the heating element projecting a grilling thermal energy into the grilling channel during a use, whereby an item-to-be grilled, positioned within the grilling channel by a user, receives the grilling thermal energy.

According to another embodiment of the present invention, there is provided a bench top grill, further comprising: a first and a second safety guard, each safety guard spacing the grilling channel from respective heating elements, and respective safety guards permitting a transmission of the thermal energy from each respective heating element into the grilling channel while prohibiting a user access or a food-item access to the heating elements, thereby increasing the user safety of the bench top grill.

According to another embodiment of the present invention, there is provided a bench top grill, wherein: the grilling channel is a channel transverse to the main body unit allowing a three sided user access to the grilling channel, thereby providing a convenient duel-sided user access to the bench top grill.

According to another embodiment of the present invention, there is provided a bench top grill, further comprising: means for enabling a removal and a secure reinstallation of respective safety guards, and the means for enabling including at least a grasping means on respective safety guards for facilitating a secure user-grip during a removal and a reinstallation, whereby the guards are easily cleaned after each use and a user convenience is increased.

According to another embodiment of the present invention, there is provided a bench top grill, further comprising: a non-stick coating on each safety guard, thereby facilitating quick and easy cleaning of the safety guards after use.

According to another embodiment of the present invention, there is provided a bench top grill, wherein: each respective safety guard is a wire grid guard, whereby respective wire grid guards provide a divided access to respective heating elements thereby improving a user safety while permitting a user to visually confirm heating element operation.

According to another embodiment of the present invention, there is provided a bench top grill, wherein: respective ones of the heating elements are at least one of an electrically resistive-based heating element, a combustion-based heating element, a photonic-based heating element, and a combination of selected ones of the same, and the bench top grill includes at least one energy control circuit means for controllably supplying an energy supply to the heating elements during the use in a parallel or a series electrical circuit, thereby improving user safety of the bench top grill.

According to another embodiment of the present invention, there is provided a bench top grill, further comprising: at least a first means for switchably controlling an operation of the energy control circuit means, whereby the means for switchably controlling enables an activation and a deactivation of the energy control means, thereby increasing user and grill safety.

According to another embodiment of the present invention, there is provided a bench top grill, wherein: the means for switchable controlling includes a user engagement means for engaging the means for controlling and the energy control circuit upon the user's insertion of the item-to-be grilled into the grilling channel, and for disengaging the means for controlling and the energy control circuit upon a user-removal of the item to-be-grilled from the grilling channel.

According to another embodiment of the present invention, there is provided a bench top grill, wherein: the means for switchably controlling includes at least one of a timer circuit, a pressure contact circuit, a photo-sensor circuit, and an on-off switch.

According to another embodiment of the present invention, there is provided a bench top grill, further comprising: at least one utensil support in the bench top grill, the utensil support being at least one of a removable and a non-removable utensil support and a mobile and an immobile support.

According to another embodiment of the present invention, there is provided a bench top grill, wherein: the utensil support is proximate at least a first end of the grilling channel, a pressure contact switch is a means for switchably controlling the grill, and the utensil support engages the pressure contact switch upon receiving a user utensil in the grilling channel during the use and disengages the pressure contact switch upon a removal of the user utensil from the grilling channel, whereby the use triggers the contact switch and the means for switchably controlling thereby increasing user safety and convenience.

According to another embodiment of the present invention, there is provided a bench top grill, further comprising: at least a first bottom surface defining a bottom of the grilling channel, the first bottom surface perpendicular to each vertical side, and the first bottom surface being at least one of a smooth surface, a non-stick surface, a recessed dripping catch zone, and a dishwasher safe surface.

According to another embodiment of the present invention, there is provided a bench top grill, further comprising: a removable drip-catching container, the bottom surface supporting the removable drip-catching container proximate the bottom of the grilling channel, whereby the container is easily removed by a user for cleaning improving the user-convenience of the bench top grill.

According to another embodiment of the present invention, there is provided a bench top grill, further comprising: a first and a second safety guard providing a divided access to the heating elements, each safety guard spacing the grilling channel from respective heating elements, and the grilling channel being shaped to allow a multiple user access to the grilling channel, thereby providing a convenient optional user access to the bench top grill.

According to another embodiment of the present invention, there is provided a bench top grill, further comprising: at least a first and a second utensil rest operably positioned on opposing sides of the grilling channel.

According to another embodiment of the present invention, there is provided a bench top grill, further comprising: at least one electronic control circuit supplying an electric current to the heating elements during use, and at least one pressure sensing switch in the control circuit, whereby when the switch is activated, the circuit is completed and the heating elements operate to grill a food item placed within the grilling channel.

According to another embodiment of the present invention, there is provided a bench top grill, wherein: at least one of the first and second utensil rests activates the at least one pressure sensing switch when receiving the weight of a user's utensil and activating the heating elements and deactivating the pressure sensing switch when the utensil is removed, thereby increasing a user safety.

According to another embodiment of the present invention, there is provided a bench top grill, wherein: each heating element has a concave shape relative to respective sides, the opposing concave shaped heating elements forming a heating center nexus zone proximate a mid-region of the grilling channel, whereby a thermal energy distribution in the grilling channel is concentrated in the nexus zone enabling a faster grilling in the zone during a use and increasing the user's satisfaction.

According to another embodiment of the present invention, there is provided a bench top grill, wherein: each heating element includes at least one nichrome wire element supported by an electrically insulated member.

According to another embodiment of the present invention, there is provided a bench top grill, comprising: a main body unit, the main body unit defining at least a first open grilling channel, the grilling channel bounded on at least three sides by the main body unit, at least a first vertical side in the grilling channel relative to a grill support surface, a first and a second guard member partially spacing a respective first and a second heating element from respective first and second sides of the grilling channel, and the first and second sides of the grilling channel being one of respective parallel sides and adjoining sides, whereby during a use, the heating elements operate to grill an item-to-be grilled positioned within the grilling channel along at least two sides.

According to another embodiment of the present invention, there is provided a bench top grill, further comprising: at least one control circuit providing an energy supply to the heating elements, and the heating elements having at least one of a planar and a non-planar shape.

According to another embodiment of the present invention, there is provided a bench top grill, wherein: the heating elements have a non-planar convex shape relative to the grilling channel, whereby the heating element non-planar shapes generate a grilling zone within the grilling channel thereby generating a grilling temperature spectrum within the grilling channel enabling a user to user-select a preferred grilling temperature during use.

According to another embodiment of the present invention, there is provided a bench top grill, further comprising: at least one pressure contact switch in the at least one control circuit, at least one utensil support proximate the grilling channel, the utensil support transmitting a user-utensil support pressure to the pressure contact switch during the use, whereby the user connects the control circuit with the support pressure and activates a safe grilling of an item positioned within the grilling channel.

According to another embodiment of the present invention, there is provided a bench top grill, comprising: a main body unit, the main body unit defining at least a first open grilling channel, the grilling channel substantially bounded on four sides by the main body unit, at least a first, a second, and a third bounding vertical side in the grilling channel relative to a grill support surface, a first and a second vertical grilling element relative to the support surface, a first guard grill spacing the grilling channel from a first heating element, a second guard grill spacing the grilling channel from a second heating element, and the first and second heating elements positioned in at least one of parallel positions and perpendicularly positions, whereby an item being grilled receives thermal energy from at least two directions during a use.

According to another embodiment of the present invention, there is provided a bench top grill, further comprising: means for engaging and disengaging each heating elements during use, and means for engaging and disengaging including at least one of a user support, a grilling utensil, a circuit control switch, a pressure sense switch, and a timer switch, whereby during the use, the means for engaging and disengaging increases a user safety during the bench top grill use.

According to another embodiment of the present invention, there is provided an electric bench top grill kit, comprising: a bench top grill and at least one utensil, the bench top grill further comprising: a main body unit, the main body unit defining at least a first open grilling channel, the grilling channel bounded on at least three sides by the main body unit, at least a first and a second vertical side in the grilling channel, a first and a second guard member spacing a respective first and a second heating element from respective first and second sides of the grilling channel, and the first and second sides of the grilling channel being one of respective parallel sides and adjoining sides, whereby during a use, the heating elements operate to grill an item-to-be grilled positioned within the grilling channel.

According to another embodiment of the present invention, there is provided an electric bench top grill kit, wherein: the first and second guard members are wire grid guard members, the wire grid guard members formed in a first wire grid size, a gripping end and a tool end on at least one utensil, and the tool end being at least one of a single-pronged end, a multi-pronged end, a basket container end, an opposing plier jaw end, and an toothed-jaw gripping end, whereby a user may grill a plurality of food items and increase the utility of the grill kit.

According to another embodiment of the present invention, there is provided an bench top grill kit, wherein: the tool end is a multi-pronged end having a second outer width dimension, and the second outer width dimension is greater than the first wire grid size, whereby the guard members prevent the utensil from contacting respective heating elements, and the user safety and the grill durability are increased.

The above, and other objects, features and advantages of the present invention will become apparent from the following description read in conduction with the accompanying drawings, in which like reference numerals designate the same elements.

### BRIEF DESCRIPTION OF THE DRAWINGS

FIG. 1 is a front elevational view of one embodiment of the present invention.

FIG. 2 is a top plan view of the embodiment of the present invention in FIG. 1.

FIG. 2A. is a perspective schematic view of an alternative embodiment of the present invention providing alternative grilling positions.

FIG. 2B is similar to FIG. 2A but shows another alternative embodiment of the present invention providing an alternative side position for grilling positions.

FIG. 3 is a sectional view along line I-I in FIG. 1.

FIG. 4 is a sectional view alone line II-II in FIG. 2 showing one embodiment of the present invention with a removable protective guard member.

FIG. 5 is a sectional view along line II-II in FIG. 2 showing one embodiment of the present invention with the protective wire grid removed, providing visual access to one embodiment of the thermal elements according to the present invention.

FIG. 6 is a side elevational view of one embodiment of the present invention.

FIG. 7 is a perspective side view of one embodiment of the guard grill member according to one embodiment of the present invention.

FIG. 8A is a top view of one embodiment of a utensil for use with the present invention.

FIG. 8B is a side view of the utensil embodiment shown in FIG. 8A.

FIG. 9 is a combined perspective view of one embodiment of the upright support with the utensil as shown in FIG. 8A.

FIG. 10 is a circuit diagram according to one embodiment of the present invention.

FIG. 11 is a top view of an alternative embodiment of a bench top grill according to the present invention.

FIG. 12 is a side view of the alternative embodiment shown in FIG. 11 in combination with a support member.

FIG. 13 is an exploded side view of the alternative embodiment shown in FIG. 11.

FIG. 14 is a top view of the support member shown in FIG. 12.

FIG. 15 is a side view of the support member of FIG. 16.

FIG. 16 is a sectional view along line III-III of FIG. 14.

FIG. 17 is a bottom view of the support member shown in FIG. 12 FIG. 18 a partially cut away side view of the bench top grill body according to the alternative embodiment.

FIG. 19 is a bottom view of the alternative embodiment of the bench top grill FIG. 20 is a top view of a guard grill according to the alternative embodiment shown in FIG. 11.

FIG. 21 is a lateral end view of the guard grill shown in FIG. 20.

FIG. 22 is a side view of the guard grill shown in FIG. 20.

FIG. 23 is a face-side view of a heating element according to the alternative embodiment shown in FIG. 11.

FIG. 24 is an end-side view of the heating element shown in FIG. 23.

FIG. 25 is a top view of the support bracket assembly according to the alternative embodiment of the present invention shown in FIG. 11.

FIG. 26 is a front view of the support bracket assembly shown in FIG. 25.

FIG. 27 is a right side view of the support bracket assembly shown in FIG. 25.

FIG. 28A is a top view of an alternative type of utensil employed with any embodiment of the present invention.

FIG. 28B is a side view of the alternative type of utensil as shown in FIG. 28A.

### DETAILED DESCRIPTION OF THE PREFERRED EMBODIMENTS

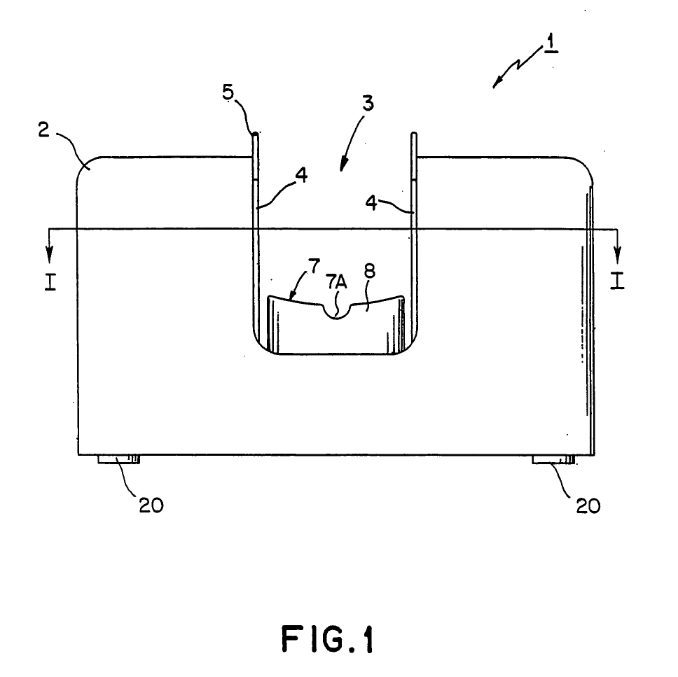

Referring to FIG. 1, one embodiment of a bench top grill 1 includes a main body unit 2 defining and at least one open channel or grilling location 3. In the embodiment shown, it should be understood that open or access channel 3 partially or laterally partitions main body unit 2 and that, in turn, main body unit by definition bounds channel 3, here on three sides (left-right-bottom). As shown, grilling location 3 is open for access on at least two sides, and the present design enables use by one or two people simultaneously, as will be further described. Principally, it should be understood that grilling location 3 is available for general lateral access from at least one side (one end of the channel being blocked).

It is envisioned that alternative embodiments may include additional open channel or grilling locations positioned in multiple configurations relative to the present open channel 3, forming, for example a cross (+) or X-shaped combined-open-channel. Alternatively, additional open channels 3 may be positioned in parallel to the present channel, dividing main body unit 2 into generally parallel sections. Alternatively, open channel or grilling locations may be positioned on the side of main body unit, as will be later described. In this manner, alternative embodiments of the present invention may easily accommodate more than two users while providing a simple lateral access to the grilling channel.

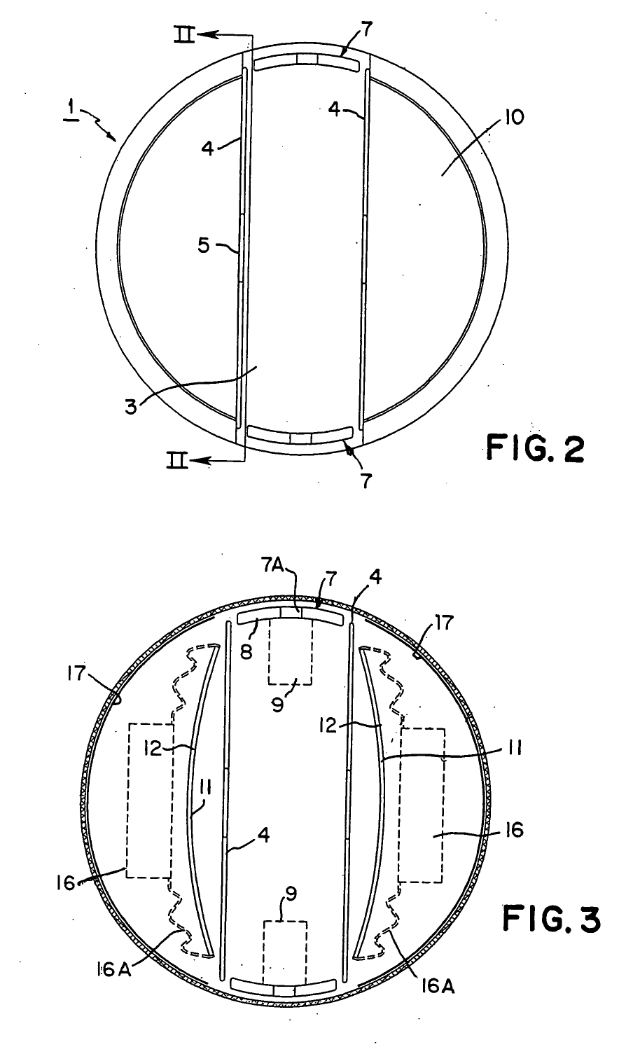

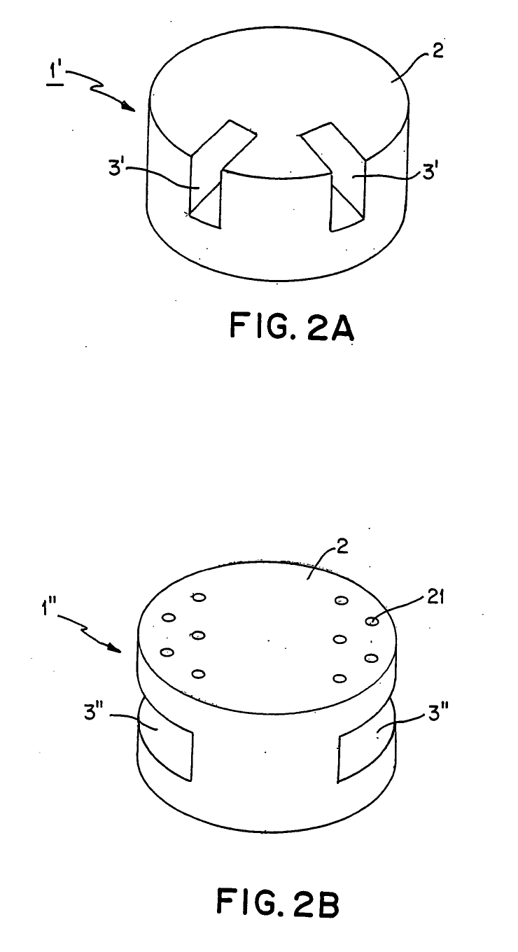

Referring now to FIGS. 2 and 3, a set of wire guard grills 4, 4 bound respective sides of access channel 3 and prevent an item to be grilled or a grilling utensil from contacting the associated heating elements (discussed later). A handle 5, positioned on a top portion of each grill 4, allows simple removal from main body unit 2 for cleaning or repair. As will be noted later, wire guard grills 4, 4 are securely retained in main body unit 2 by associated retaining openings, legs, clips, or in other common manners enabling secure insertion and simple removal from main body unit 2.

Guard grills 4, 4 are constructed from a suitable material capable of withstanding the thermal effects of grilling (while enabling simple cleaning), providing a desirable appearance, allowing a rapid and inexpensive construction, and most importantly providing a safety feature or guard limiting access to heating elements (described later). In the present embodiment, grill 4 is constructed from stainless steel, but may be alternatively constructed from another suitable material, for example hardened aluminum, stiffened silicon, ceramics or a combination of materials in alternative forms effective to achieve the same desired result. Guard grills 4, 4 may include an additional non-stick coating allowing a user to conveniently place the grills into an automatic dishwasher.

Feet 20 space grill 1 and main body unit 2 from a support surface and minimize thermal transfer and damage to the support surface. It is envisioned that the present grill 1 may be incorporated with or sold with a rigid or a rotational base.

As shown, main body unit 2 is cylindrical in nature with open channel 3 partially bisecting the general shape. An outside surface of main body unit 2 is generally smooth, non-porous, and free of sharp corners facilitating both cleaning and ease of movement. It should be understood by those skilled in the art, that main body unit 2 may be realized in multiple attractive geometries including square, rectangular, or other creatively selected polygons or amorphous shapes effective to form a type of open or closed channel 3, in either a three, four, or five sided forms (each allowing a lateral access, as will be described).

It is also envisioned, that the external surface of main body unit 2 may be shaped or molded into various pleasing forms, for example to replicate a brick/stone pattern, a floral pattern, a culturally selected pattern such as a Chinese-type grill or an South-Asian-type grill, or other desired form. It is also envisioned, that the external surface of main body unit 2 may include additional receptacles, vents, drawers, sliding trays, slots, or means for containing items to be grilled, utensils or utensil containers and prevent them from shifting. Body unit 2 may also include gripping surfaces for lifting and thermal venting openings, as will be described later. Additionally, a support plate (shown later) may be combined with grill 1 in an assembly or a kit form.

In the embodiment shown, main body unit 2 is made from a selected UL (Underwriters Laboratory) double insulated plastic (thermoplastic) housing enabling the desired ease of cleaning and movement while facilitating simple manufacture, color selection and determination, and safe electrical construction.

It should be recognized that the housing of main body unit 2 may be alternatively constructed from a variety of materials including glazed and unglazed ceramic; painted, enameled, or anodized metals, composite materials and other materials commonly used in the manufacture of rigid-shaped consumer products so long as the principals of safe and relatively simple construction are maintained. In this manner, the present invention secures consumer safety while ensuring a relatively low manufacturing cost.

A utensil rest 7 includes at least one utensil notch 7A on an upright support portion 8. In the present embodiment, an engaging member or engaging means 9 (shown later) projects away from upright support 8 and enables both an engagement between utensil rest 7 and the heating circuit(s) (described later) and a stable support of utensil rest 7 within body unit 2, a utensil (shown later), and an item to be grilled. In this manner, the present utensil rest 7 serves as both a tool rest and enables operation of a safety switch or safety means (described later) for consumer protection.

It is envisioned, that the present tool rest 7 design is merely one embodiment of a means for supporting the utensil and item to be grilled and alternatively and adaptively actuating the heating elements (shown later). In this manner, the present invention envisions multiple designs for utensil rest 7, each capable of performing at least the desired utensil support function, and optionally the additional functions mentioned. In the present embodiment, tool rest 7, operates as a means for supporting the utensil, may additionally include a two or three point-type of support contact and allow the grilling of heavy or nonuniform items-to-be-grilled without constant user supervision.

The engaging and disengaging feature of utensil rest 7 may be performed through a variety of envisioned designs wherein the support portion 8 or engaging member 9, or both, enable an electrical connection between an electrical circuit (shown later) and the heating elements (shown later), either by providing the electrical conduction themselves, or depressing or contacting or engaging a switching contact to facilitate the same result.

The present invention envisions the combination of these items as a convenient means for engaging a safety control, and that alternative designs exist for this function and for embodiments not having a safety control function. It is also envisioned that, as an example, the means for engaging and/or disengaging the safety control may be a circuit contact within notch 7a, where utensil 15 depresses or completes a circuit when it rests in notch 7a. Those skilled in the art of consumer device design will additionally recognize that alternative center-contact, non-contact, or photo-sensor based designs exist for meeting the safety control function envisioned by the means for engaging the heating elements.

In sum, it should be clear to those skilled in the art that multiple embodiments exist for utensil rest 7 and for designing means for engaging a safety control to the electrical circuit (as will be shown).

Utensil rest 7 is constructed substantially from a tough and easily cleaned non-porous material such as thermoplastic, coated metal, ceramic or other material effective to function as described while having smooth edges for safety and appearance benefits and enabling easy cleaning between uses.

Referring now to FIGS. 2 and 3, it is clear that main body unit 2 encloses at least two heating elements 11, 11, on either opposing (shown) or adjoining sides, and supported by electrically resistive mica board supports 12, 12 (as will be shown in more detail later). Seen in this view, it is clear that supports 12, 12 are presently shaped to focus the thermal radiation from heating elements 11, 11 toward open channel 3 and generate a directed heating center or foci range within open channel 3. An alternative embodiment provides planar supports 12, 12, and elements 11, 11 providing a more uniform thermal radiation along the length of channel 3, dependant upon a consumer or manufacturer demand.

A pair of connective wires 16A, 16A electrically connect respective circuits 16 with respective ends of heating elements 11, as shown. An electrical plug (not shown) joins circuits 16, 16, heating elements 11, 11, and the switches controlled by utensil rests 7, 7 with an outside electrical supply.

The present electrical circuit is envisioned as having heating elements 11, 11 linked in parallel and in series with two parallel-circuit safety switches, where the switches are in series with the heating elements, alternative designs should be envisioned by those skilled in the art of consumer electronic circuit design.

The control circuit for proposed heating elements 11, 11 may additionally include a warning or “on” indicator light (not shown) in a form common to the trade as one of several envisioned safety features. In this manner, actuating either safety switch 7 operates both heating elements 11, 11 while providing a safe circuit design easily modified to accommodate manufacture adaption of the present embodiment shown. Alternative designs of the present invention may include additional elements within the present electrical circuit, for example, timers, motion sensors, alarms, fuses and other safety devices.

The present embodiment employs nichrome wire as heating elements 11, 11 joined with their respective supports 12, 12. It will be readily understood, that the present invention envisions that heating elements 11, 11 may be formed from any suitable material or item including electrically resistive metal and ceramic-metal alloys, ceramic thin films, halogen, gas, or arc lights, or other typical items common to the field of consumer heating elements, that are effective to heat or grill items positioned within channel 3.

An alternative embodiment (not shown) of the present invention provides heating elements as gas grilling surfaces where a gas supply feeds small and controlled amounts of a flammable gas to opposing shaped heating supports where the gas is then ignited and flows upward along a heating element surface (similar to the present design not shown) under gravity creating a dual sided vertical gas-grilling effect. In this embodiment, the top and or bottom surface of main body unit 2 would be pierced or partially open to allow the venting of combustion gasses and an easy, but safe, access during use. In use, the present embodiment provides a dual sided grill enabling a user to position an item to be grilled between opposing sets of flames or resistive elements.

It should be understood, that circuits 16, 16 are conventionally constructed to receive a household line current, commonly 120V in the U.S., and to transmit the current in a form effective to operate the selected type of heating element 11, 11. Commonly, circuits 16, 16 and connective wires 16A may alternatively include transformers, cut off switches, fuses, timers, out-of-level sensors, alarms signals, alarm lights, and alarm switches, and other elements common to the consumer product market and functionally effective to provide a safe and convenient bench top grill to the public. As noted above, where an alternative embodiment requires alternative supply (e.g., gas supply, 220V, etc.) that supply would be similarly connected to the requisite alternative type of heating element 11.

A support 10 having a top surface 13 (shown later) is positioned proximate a bottom of main body unit 2 and functions to distance heating elements 11, 11 and heating supports 12, 12 from a bottom inner surface of main body unit 2. Support 10 may be optionally employed to support supporting guard grill 4, as will be shown and explained. Support 10 may be a single integral unit spanning substantially the entire bottom of main body unit 2, or alternatively, a sectional arrangement, including a channel-section suitable for catching dripped materials within channel 3 and for easy removal for washing, while maintaining one or more outer support sections below heating elements 11, 11.

In the present embodiment, an insulation layer 17, 17 is positioned partially on an inner surface of main body unit 2 as shown, and serves to insulate and separate heating elements 11, 11 from the inner surface of main body unit 2. Insulation layers 17, 17 function to protect the walls of main body unit 2 from thermal degradation while simultaneously increasing the consumer safety of the unit.

While in the present embodiment thin insulation layers 17, 17 are made from flexible mica, those skilled in the art will readily understand that the present invention envisions alternative embodiments involving both differing shapes and constructions and consequently alternative types of insulation. For example, flat or geometric walled body units would require corresponding flat or geometric shapes and differing materials such as fiber-glass, ceramic insulation, or alternatively no insulation where an embodiment (ceramic or metal body unit) requires little thermal protection.

As shown, connective wires 16A are slightly bent or kinked allowing for flexibility and movement, during installation, cleaning, and use, without later degradation during multiple thermal cycles. Connective wires 16A, 16A may be the single leads shown joining each side of a single heating element 11 to its respective circuit member 16, or alternatively, wires 16A, 16A may be a plurality of electrical connections, in various connective circuits (serial or parallel), depending upon the type and construction of heating element 11 selected by the manufacturer, (including the above-noted gas heating type elements, where wires 16A, 16A would alternatively be gas feed lines to gas-burning heating support elements 11).

Those skilled in the art will recognize that it is additionally envisioned that each heating element 11, or open channel 3, may be constructed with alternative geometries, for example heating elements 11 may be flat, have an alternative two dimensional arcuate shape or three dimensional arcuate shape (e.g., portion of a sphere's or a cylinder's surface including an ungula-like form), be angular, or in a side-lateral view have a non-rectilinear shape controlled by the shape of an alternatively designed main body unit 2.

The selected embodiment shown in FIG. 3, is one alternative embodiment with curved heating elements 11, 11 each enabling a heating center foci range (i.e. a thermal convergence zone) including and within the defined grilling zone in open channel 3. In operation of the embodiment shown in FIG. 3, each heating element 11 warms it projects heat rays/energy wavelengths outward and into a three dimensional grilling zone positioned (at least in part) within open channel 3.

The two-dimensional curved shape of each heating element 11 focuses a greater quantity of thermal energy toward the center of the grilling zone in the form of a three-dimensional pseudo quadrant or pie-shaped wedge portion having a height defined by the height of each heating element 11.

Since the opposing heating element 11 operates in a similar manner, the grilling zone, physically defined relative to the open channel 3 and thermally defined relative to the shape of each heating element 11, 11, receives greater thermal energy than the outer extremities of open channel 3. In other words, in the present embodiment, the thermal energy concentration within open channel 3, while broadly shaped, is non-uniform by design and includes a high energy grilling zone proximate the general central region of open channel 3 where food items are typically positioned. Consequently, while use of flat-shaped heating elements (and a consequently uniform grilling zone) is perfectly acceptable for many users, certain other users wishing to increase a grilling or cooking rate of a food item, or have a non-uniform thermal energy zone within channel 3, may preferentially desire selectively shaped heating elements 11, 11 enabling a user's grilling-rate discretion based upon the food items position within channel 3.

Another embodiment (not shown) may include heating elements 11, 11 formed in a three-dimensional arcuate shape (not shown), or heating elements 11, 11 positioned on adjoining sides of an open channel (for example, this positional option is possible within FIGS. 2A and 2B, as will be discussed).

In the present embodiment shown, utensil rests 7 are shaped to reside partially within main body unit 2 and either actuate a connecting safety switch (not shown), or complete or engage a safety switch of a type commonly known in the consumer product markets, leading from respective control circuits 16 to respective heating elements 11 upon contact with a user's utensil or upon pressure from the utensil. Alternative embodiments may position singular utensil rests 7 opposite four sided channels (discussed later), or utensil rests projecting outward from a vertical side of an open channel (described later). One skilled in the art will recognize the multiple designs envisioned herein for utensil rest 7 may be easily adapted to the multiple designs envisioned for main body unit 2 and open channel 3.

Referring additionally to FIG. 2A, it is also recognized that open access or grilling channel 3 may be reformed into close-ended opening 3′, only partially bisecting main body unit 2, bounded on four sides (four-sided three vertical sides and one horizontal bottom side), as shown. In this embodiment, it is envisioned that a bench top grill 1′ would include multiple channels 3′ for multiple users (two are shown but more may be provided based on geometry and a manufacturer's preferences).

In this alternative embodiment, heating elements (not shown) may be positioned on opposing vertical faces (similar to the embodiment shown in FIG. 3) or on adjacent planes (the front and a left side face) dependant upon a user's desire. It is also envisioned that heating elements may be positioned on up to three joined planes (front and left and right side faces). In each embodiment described, dual plane grilling is provided along the vertical allowing grilling detritus to fall vertically downward into a receiving container, or onto a receiving surface (also not shown) for later cleaning ease without damage to the grilling elements.

In this embodiment, a utensil rest (not shown) may be positioned at a horizontal edge of opening 3′ or along a vertical edge dependant upon operator design. Those skilled in the art of consumer product design, will readily recognize the easy adaptability of the above-described utensil rest 7 to alternative positions and shapes for open channel 3.

Referring now to FIG. 2B, as another example of the present invention, there may be two or more close-ended (three sided, top, bottom, side) openings 3″ accessible about an outer perimeter of a main body unit 2 (as shown) or about an outer side of a quadrate polygon shape (not shown), of an electric bench top grill 1″, as shown. It is also envisioned, that as discussed briefly above, there may be additional heating elements on the third side of a grilling channel or open channel 3″ in the alternative three sided close-ended opening embodiments. In the instant embodiment, a plurality of vents 21.

As noted above, open channel 3″ and its position on main body unit 2 may be optionally determined by a manufacturer during consumer testing. It should be understood, that in each embodiment, the main elements discussed above are merely repositioned or adapted to accommodate the new grill channel enabling similar principals of operation, including the similar alternative use of a designated grilling or thermal zone.

In this embodiment, heating elements (not shown) may be positioned on the horizontal top surface and the adjoining vertical inner plane, while grill grates would similarly protect the horizontal top surface and adjoining vertical surface. These thermal elements may be flat or, as noted above, arcuate in two or three dimensions and thereby capable of forming a grilling or thermal zone. One skilled in the art should also envision that the heating elements in this embodiment, while not positioned in an opposing manner, may be easily shaped to generate the heating center foci or range within the grilling zone defined by opening 3.″ As noted above, and in the present embodiment, utensil rest 7 may have multiple designs each effect to achieve at least the function of supporting a user's utensil during grilling.

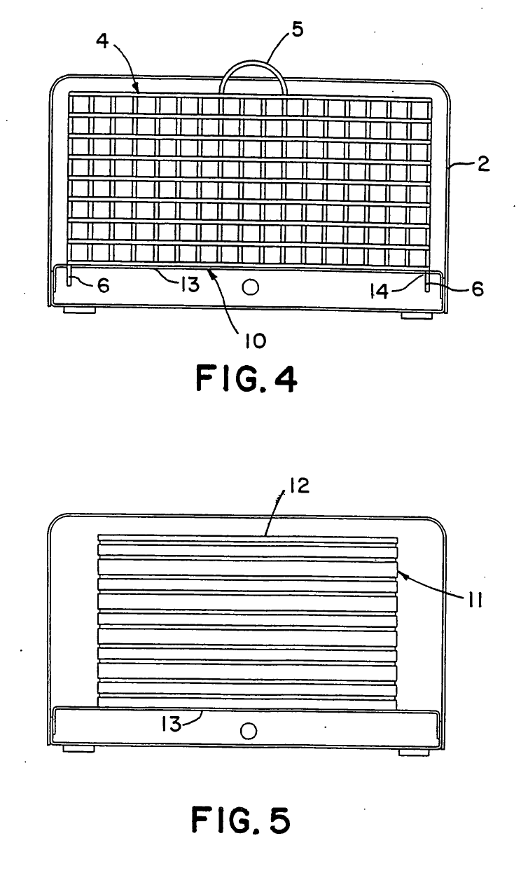

Referring now to FIGS. 4 and 5, it can be seen that insert 10, in the single member shown or in the multiple elements as described, includes a floor surface 13 having at least a pair of openings 14, 14 formed to receive legs 6, 6 of each respective guard grill 4. As should be additionally noted, insert 10 is spaced above the floor of main body unit 2 providing a thermal insulation distance and preventing thermal transfer from heating elements 11, 11 to the body of main body unit 2. Where necessitated by alternative designs, insert 10 may include vents allowing air to travel from below the unit out the top through channel 3.

In the present embodiment, insert 10 is fixed in place and during cleaning the remaining elements are removed so that a user may wipe down floor surface 13 of insert 10. An hinged or removable access panel (not shown) may be optionally included in the design allowing user access to the insulation space between insert 10 and the floor of main body unit 2.

Alternative embodiments envision a removable insert 10, in a single or multiple unit construction. One alternative embodiment may include a waste area or spill receiving area (both not shown) on insert 10 formed to receive and retain crumbs, drippings, and items to be removed after use, thereby increasing a functional utility of grill 1. An alternative embodiment may also include some form of removable drip pan (not shown), constructed from metal or ceramic (for example), and positioned within or below open channel 3 and the grilling zone or extending between sides of, and allowing operation of utensil rests 7 while providing a simple waste catching function with an easy cleaning design.

It should be recognized by those skilled in the art that openings 14 in floor 13 and legs 6 together form a means for securing and removably-retaining guard grill 4 during use. The means for securing may alternatively include sliding channels on the edge of main body unit 3, securing clips, fixed magnets resistive to thermal energy, or other means effective to function as desired, namely to secure and retain guard grill 4 in channel 3 during use. Another alternative embodiment may include laterally projecting feet or claws on the bottom of legs 6 that would provide additional stability when positioned on insert 10 or clipped into spring clips (not shown) on insert 10.

As shown in the present embodiment of FIG. 5, heating element 11 includes electrically resistive nichrome wire positioned on heating element support 12 formed from a mica board and shaped to focus thermal energy toward the general center of channel 3 forming a heating center foci or area (either two or three dimensionally). As briefly discussed above, and as shown, heating element 11 (including support 12) has a rectangular shape in side view (arcuate in top view). Those skilled in the art will readily understand that the spirit of the invention additionally includes non-rectangular shapes in side view, for example, partially oval or circular, curved, or other polygonal shapes may be used, where a grill designer decides for aesthetic or functional reasons to modify the shape and or generate a central heating foci or area within the grilling zone defined within each channel 3, 3′, and 3″.

An alternative embodiment of the present invention may additionally include venting mechanisms, including a singular opening or a plurality of holes around the top and/or base of main body unit 1, 1′, 1″ (the floor of body unit 2), insert 10, or the outer bottom periphery of main body unit 2. These openings, may even include a hinged or removable door, allow optionally, both the entry of venting/cooling air and for the removal of accidental debris. One type of venting holes is shown as heat vents 21 on the top surface of bench top grill 1″ in FIG. 2B. In operation, heat from respective channels 3″, 3″ would exit vents 21, maintaining an operably cool top surface on main body unit 2.

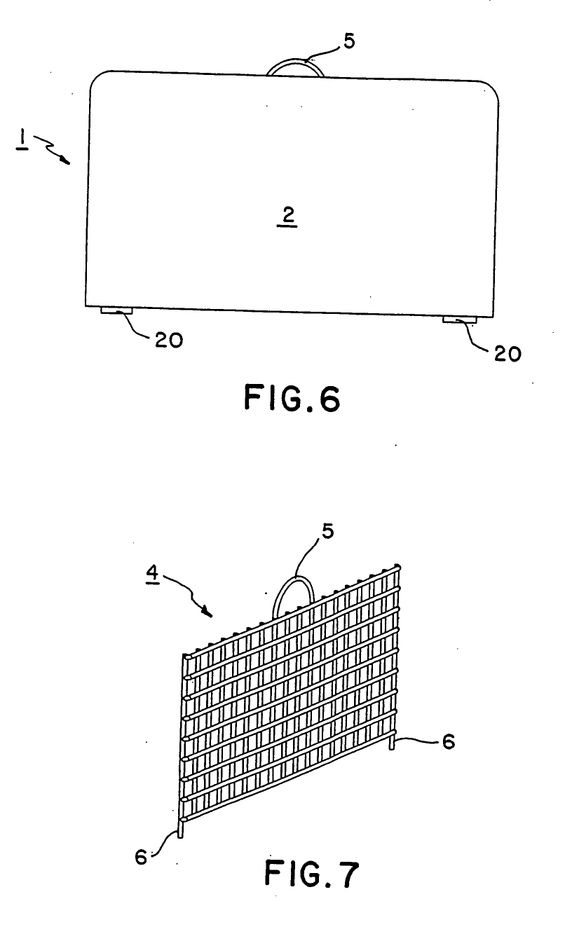

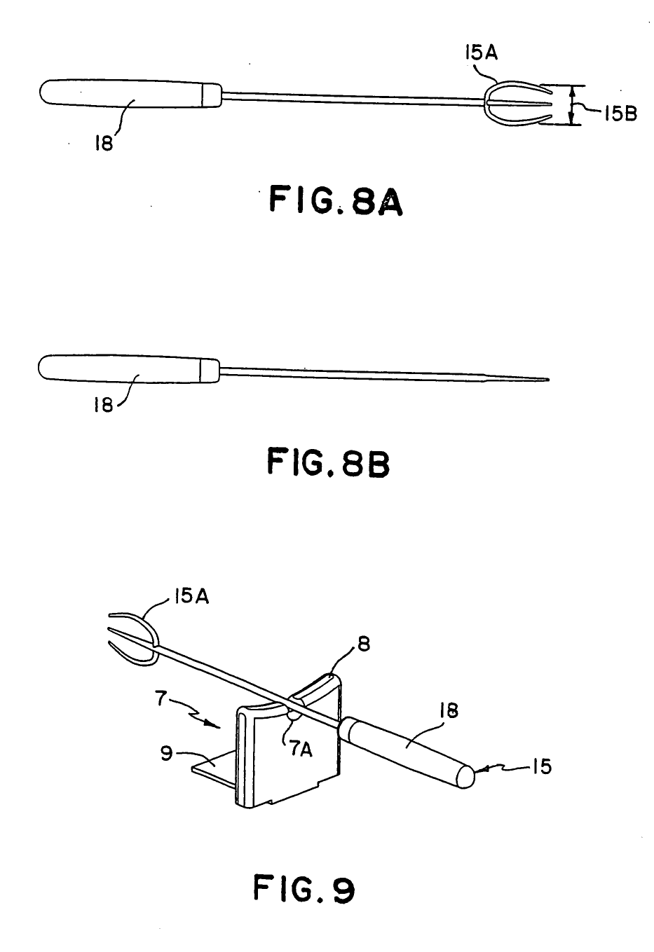

Referring now to FIGS. 6 through 9, handle 5 projects beyond a top surface of main body unit 2, facilitating easy and quick removal of guard grills 4 for cleaning or insertion. An alternative embodiment may eliminate handle 5 or provide for a handle portion bent outwardly or positioned below the top surface, depending upon user design, without departing from the scope and spirit of the present invention.

A utensil 15 is shown as a fork having both a handle 18 and a set of tines 15A. Tines 15A define a maximum width 15B. One safety feature of one embodiment of the present invention is that an assembly or kit including grill 1, 1′, or 1″ and a plurality of utensils 15 with tines 15A ensures that width 15B is greater than the width of openings in respective guard grills 4, 4. Consequently, the present utensil design prevents a user from inadvertently inserting tines 15A through guard grill 4 and into heating element 11, causing damage or a short circuit. In this manner, the present design includes multiple user safety features. It will be readily apparent to those skilled in the art that a plurality of utensil designs and grill guards are employable with the present bench top grill embodiments to achieve the same user safety goals without departing from the spirit and scope of the present invention.

While the present utensil 15 includes tines 15A for securing an item to be grilled, for example, corn, marsh mellows, hot dogs, peppers, meat balls, knish, smores, shish kabob, fruit items or pieces, etc., those skilled in the art will recognize that without departing from the essence of the invention, utensil 15 may alternatively have a caged end (not shown) for capturing and containing items difficult to penetrate with tines 15A (e.g., chestnuts, cauliflower heads, acorns etc.) or small items more easily grilled in a cage (for example, peanuts, walnuts, etc.), or even types of shrimp, clams, muscles, scallops, and fish.

As shown, utensil rest 7 with upright support 8 may include additional supports (not shown) to support the entire length of utensil 15, enabling hands-free grilling. This alternative embodiment would allow a user to simply rest utensil 15 on rest 7 for convenience and grilling uniformity. Another alternative embodiment of the present invention envisions utensil rests 7 formed integrally with the main body unit. Those skilled in the art may readily envision utensil rests 7 formed in a manner functioning as both a utensil rest, and where desired by a customer an integral portion of a safety circuit enabling an on-off function of respective heating elements. In this manner, utensil rests 7 are easily retained with the bench top grill unit 1, 1′, 1″ while enabling a user to reap the benefits of the envisioned functional elements described above.

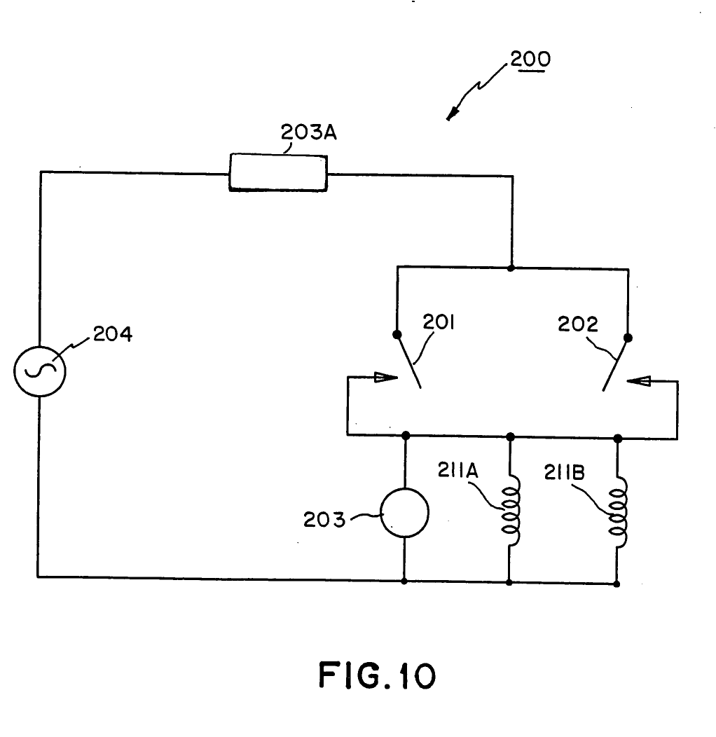

Referring now to FIG. 10, a control circuit 200, or circuit means, is shown according to one embodiment of the present invention. Circuit 200 includes a power supply source 204 in series with an optional indicator light 203 and heating elements 211A, 211B. A set of switches 201, 202 are positioned in parallel relative to the respective heating elements and indicator light. An optional electronic device 203A may be positioned in series with circuit 200 and provide a variety of alternative or additional safety feature. As discussed more fully below, control circuit 200 may easily include a variety of additional elements, switches, safety shut-offs etc. and remain within the boundaries and scope of the present invention.

For example, device 203A may be a timer, temperature range setting device (varistor/resistors etc.), arc-fault detector, optical sensor, or other safety device providing an automatic or calculated operation control of circuit 200. Those skilled in the art of designing consumer electrical supply circuits will recognize that actuating either switch 201, 202 provides a current path to both indicator 203 and elements 211A, 211B. In this manner, control circuit 200 with switches and sensors as describes enables an immediate user-warning, via indicator light 203 and/or device 203A, upon the engagement of either switch 201, 202.

It should be additionally recognized that modifications may be made to circuit 200 without departing from the scope and spirit of the present invention. As a first alternative, a timer or additional safety switch 203A may be positioned in sires along circuit 200 or even replace indicator light 203. As a second alternative, switches 201, 202 may be positioned in series requiring the operation of both prior to current flow. In a third alternative of control circuit 200, elements 211A, 211B may be replaced with an additional operative circuit (ceramic resistive heaters) or valving (not shown) potentially enabling supply of an alternative energy source (natural gas/propane) via supply lines and electrically operated valves. In sum, those skilled in the art will readily recognize that a broad array of alternative control circuit designs may be employed without departing from the spirit and scope of the present invention.

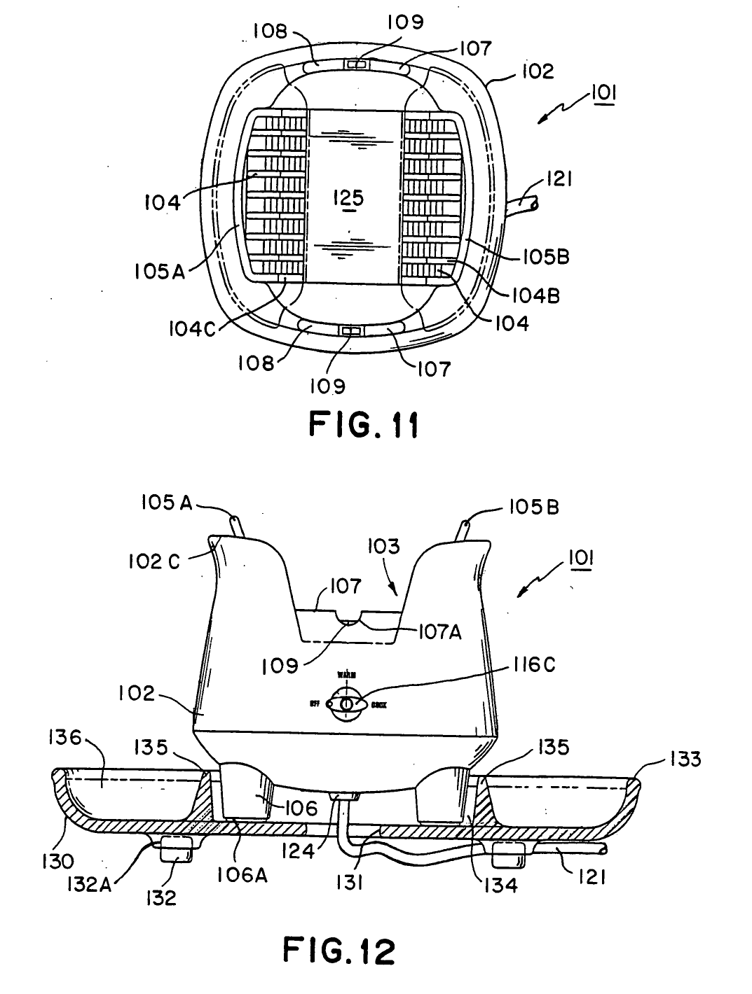

Referring now to FIGS. 11-17, an alternative embodiment of a present bench top grill is provided. An alternative bench top grill 101 includes a main body unit 102 defining at least one open channel or grilling location 103. As noted above, in the present alternative embodiment shown, it should be understood that open or access channel 3 partially or substantially partitions main body unit 102 and that, in turn, main body unit 102 by definition bounds channel 103.

The present embodiment is similarly suitable for adaptation and the grilling of a wide verity of items as discussed in detail above. Those skilled in the art, will also recognize the ready adaptation of the present embodiment along lines similar to those previously described, with alternative channel locations and positions and the use of alternative fuel sources and external design features.

As shown, grilling location 103 is open for access at least one side laterally (at least one side and the top) and is on the top of main body unit 102, and the present design functions to enable use by one or more people simultaneously. It should be further understood, that grilling location or open channel 103 is available for a lateral user access or alternative user access as described elsewhere in the specification.

Similar to the embodiments discussed above, it is envisioned that alternative designs may exist for the present embodiment and may include additional open channel or grilling locations positioned in alternative configurations as suggested above.

In the present embodiment, main body unit 102 includes a main body shell 102A having a top rim portion or portions 102C as shown, and a bottom shell member 102B. During assembly, bottom shell member 102B is fixably assembled with main body shell 102A. A plurality of legs 106 having feet 106A project from a bottom surface of bottom shell member 102B, as shown.

In the present embodiment, main body shell 102A is formed from a thermoplastic material for ease of manufacture and low cost reasons. It should be understood, that main body shell 102A and/or bottom shell member 102B may be formed from any suitable material capable of supporting the internal elements therein and being cleaned readily by a users. Suitable materials may include, plastics, metals, glasses, polycrystalline ceramics, and combinations thereof. Main body shell 102A functions as a supporting member for supporting a plurality of internal components, as will be described; and as a safety member, spacing a user from heating elements and electrical circuitry, as will also be described. Main body shell 102A also may include additional utensil slots, or food storage recesses (both not shown) for a user's convenience.

Legs 106 serve to space main body unit 102 from a support or other surface and provide access to bottom vents 123 (shown later) and passage of a power supply cord (shown later). Feet 106A may be formed from any suitable material including elastomeric, metal, ceramic, or natural materials. Feet 106A function to both seal the opening formed within legs 106 during the plastic mold-forming of bottom shell 102B. Where main body shell 102A is formed by alternative means or from alternative materials, it should be understood by those skilled in the art that legs 106 and feet 106A may be easily adapted for alternative use without departing from the scope and spirit of the present invention.

An optional grommet 124, positioned on a bottom surface of bottom shell 102B, provides a smooth-edged access to an inside of main body unit 102 as shown. An electrical wire 121 projects through the opening defined by grommet 124 from the inside of main body unit 102 and supplies electrical power to an electrical circuit, as will be described.

A set of utensil rests 107, 107 project from body shell 102A at either end of open channel 103 as shown. Each utensil rest 107 includes an upright support 108 having a curved notch 107A for utensil stabilization, as will be described. An alternative embodiment having only one utensil rest 107 is envisioned where channel 103 is fully closed at one end, in a manner discussed in previous embodiments.

A set of utensil supports 120, 120 are positioned in main body unit 102 proximate each upright support 108 in utensil rest 107. Each utensil support 120 includes edges 120A, on opposing sides of a guard or contact portion 120B. During assembly, a portion of guard 120B projects within notch 107A in upright support 108 forming (together with other functional elements) an engaging means 109, as will be described.

During use, as will be described more fully below. A user places a utensil (shown later) within open channel 103 and rests a handle of the utensil within notch 107A on utensil rest 107 and consequently provides a contact or an activation signal to engaging means 109.

As will be described later, similar to the embodiment noted above, engaging means 109 serves as an actuation point for operation of the heating elements (described later). Those skilled in the art will understand that engaging means 109 may additionally incorporate and link with pressure switches, magnetic switches and sensors, trip switches or other commonly know switch devices capable of detecting the presence of a utensil within open channel 103 and activating the control circuit (as will be described).

A guard 104 is positioned within open channel grilling channel 103 as shown. Guard 104 includes an outer continuous bounding member 104C. A plurality of cross members 104A and long members 104B positioned between sides of outer member 104C form a safety grid. As shown, outer member 104C is a larger gauge than cross and long members 104A and 104B, although any range of suitable sizes and forms and compositions (square, round, oval, stainless steel, ferrous alloys, aluminum alloys, rigid silicon etc.) of material may be used for wire guard 104.

Those skilled in the art should recognize that the purpose and function of wire guard 104 is similar to the guard-embodiment noted above, namely to space the items being grilled (and any utensils) from inner heating elements (shown later). In sum, the wire guard 104 in the present embodiment provides a safety function. Portions of outer member 104C above an upper long member 104B and cross member 104A function as handles or handle portions 105A, 105B. Handle portions 105A, 105B may alternatively include heat resistant portions made from a ceramic of other material allowing ready grasping by a user when hot.

A drip pan or shield 125 having bent upward edges 125A is removably, or optionally securely, positioned at a bottom center region of guard 104, as shown. Shield 125 is positioned within and generally aligned with open chamber 103. Shield or pan 125 functions to receive drips and falling items during grilling and may alternatively include a central recessed portion (not shown) or may be constructed of a smaller mesh size. Shield or pan 125 may be formed from any suitable material capable of functioning as described and may include recesses or channels to contain any grilling detrius. Examples of suitable materials include metal or thermally resistant silicon, coated metals, or removable and disposable foil products.

The present invention also envisions an alternative guard 104 formed without a bottom guard or shield 125, and correspondingly, bottom surface 111 in the support bracket assembly 110 may be shaped to receive drips and other falling items. In sum, the present invention recognizes that alternative embodiments may exist without departing from the spirit and the scope of the present invention.

During use, those skilled in the art will recognize that a user may grasp handles 105A, 105B and remove guard 104 from channel 103 along with drip shield or pan 125 and withdraw the guard from main body unit 102 for immediate cleaning or placing the grill on a thermal pad. Drip shield or pan 125 may also be fixed to guard 104 for user convenience. Alternative embodiments are envisioned which position guard 104 fixably within channel 103 and allow the removal of only drop shield or pan 125 depending upon a manufactures desires.

A switch mechanism 116C is positioned on an outer surface of main body unit 102 as shown and may additionally include a light or dial mechanism. As will be noted, switch 116C serves as an additional control means for bench top grill 101. Those skilled in the art will note that switch 116C may include, or link with, a timing mechanism, arc-fault detector, a temperature selector, an operation indicator (warm, cook, off etc.) or any other type of commonly used switch mechanism used in consumer heating products.

As will be later described, switch 116C functions in conjunction with engaging means 109, wire 121, heating elements (shown later) in a control circuit (discussed later) providing for the safe supply of electrical current with at least one use-dependant shut-off feature. Those skilled in the art of electrical design for consumer products will recognize that bench top grill 101 may be designed without switch 116C, and even without engaging means 109 without departing from the spirit, scope, and function described. The additional features are provided as alternatives within the present embodiment allowing design freedom to manufacturers.

Those skilled in the art of circuit and product wiring design should readily recognize that switch 116C may be easily integrated in to the type of circuit design 200 shown in FIG. 10. Switch 116C may operate to control a modified circuit 200 and may even function in place of or in addition to engaging means 109 to ensure a user's safety and convenience of operation.

A support member 130 may be optionally provided with or within bench top grill 101 as an assembly or in a kit form for convenient sale to a consumer. In the present embodiment, support member 130 is shown including a rounded outer rim or wall 133 and a plurality of feet 132 spacing support member 130 from a support surface. Feet 132 are positioned within recesses or depressions 132A formed on a bottom surface of support member 130, as shown. An opening 131 formed through support member 130 provides clearance for electrical support wire 121 or other means of energy supply (gas pipe) where bench top grill 101 is adapted for flame use. In the present design, feet 132 space the bottom of support member 130 sufficiently from a work surface to allow wire 121 to pass from hole or opening 131 along the bottom of member 130 to an external receptacle without causing member 130 to tilt or be wobbly and cause a safety risk.

As shown, support member 130 includes a receptacle 134 for main body unit 102 defined by elements of raised portions 135 projecting from a bottom of support member 130. In the present embodiment, receptacle 134 generally centralized, is shaped in a generally quadrilateral form (4-sided) allowing for the positioning of legs 106 and main body unit 102 on opposite quadrants. Support member 130 function to space main body unit 102 from a support surface and, in part, prevent any stray thermal transfer to the work surface. Support member 130 also functions to enable the easy transport of main body unit 102, and any desired food products (condiments), utensils, container dishes or other items commonly used in personal cooking devices. Receptacle 134 serves to position main body unit 102.

Alternative designs for support 130 are envisioned for multi-legged designs or designs no feet or rounded shapes and requiring a cylindraceous (generally rounded shape) form. Alternative designs are further envisioned positioning receptacle 134 proximate an edge of support member 130, or in multiple positions where a large support member 130 is employed. Although support member 130 is shown in a rounded-quare form, alternative shapes are envisioned including round, rectangular, and free-form shapes more suitable for multiple users or the need for a wider support surface.

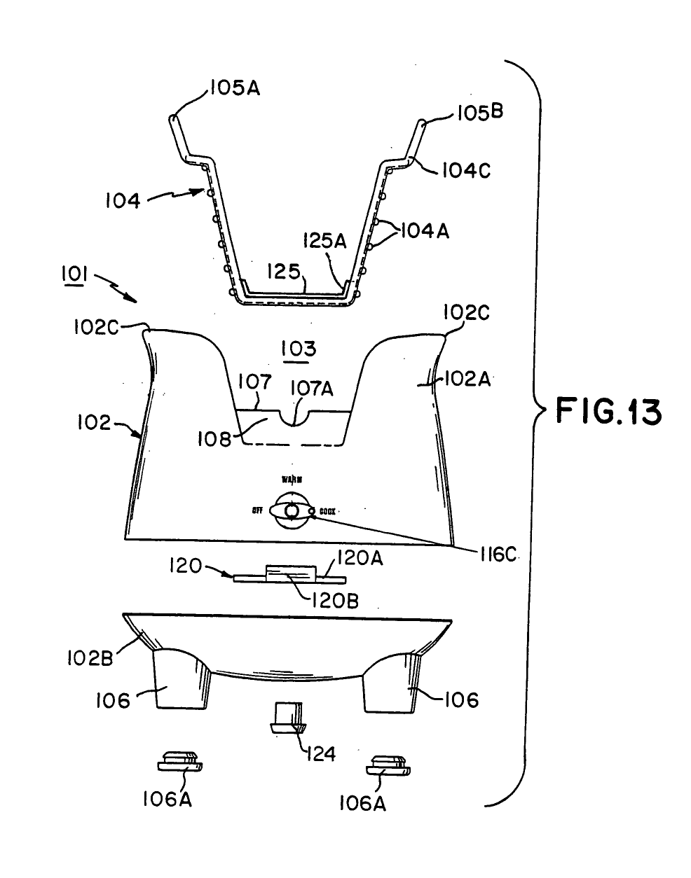

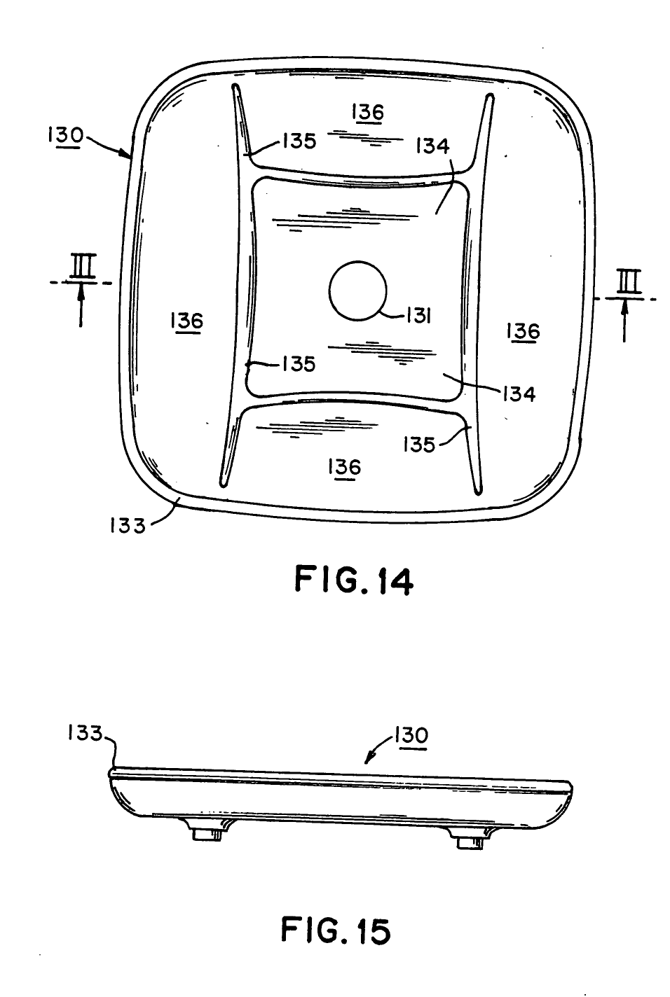

As noted more clearly in FIG. 14, raised portions 135 are formed and extend upward or project outwardly, from the region of receptacle 134 toward outer walls or rim 133. As a result, raised portions form a plurality of receptacles 136. As shown in FIG. 14, raised portions 135 form four receptacles 136, two of an elongated nature, and two of a shorter nature.

Those skilled in the art of plastic forming, ceramic slip casting, dry pressing, wood carving or metal forming will readily recognize the easy adaptability of the present design for support member 130 to adaptively include different designs for receptacles 136 and raised portions 135 depending upon a manufacturer's or consumer's needs. It is expected that the present design for support member 130 may be adapted to contain a wide variety of cooking, grilling, and/or cleaning utensils, drink glasses and food items (noted above) or even adaptively shaped food containers. For example, receptacles for elongated containers for chocolate bars and rounded containers for marsh mellows, vegetables, meats or other food items may be formed.

Referring now to FIG. 18 an internal support bracket assembly 110 includes side members 112 (one not shown) extending from an internal surface in main body unit 102 toward top rim 102C. A bottom member 111 spans the distance between respective side members 112 and provides an air gap between the internal surface and the bottom of guard member 104 as shown. This air gap or space provides a useful rout for wiring and circuitry (as will be explained) and optionally provides a thermal break or insulation means as an additional safety feature.

A heat shield member 117, in the form of mica insulation or other suitable insulation means is formed proximate the outer surfaces of side members 112 and spaces at least a portion of bracket 110 from the outer wall of main body shell 102A. In this manner, thermal energy from the heating elements will not detrimentally affect main body unit and the thermal energy is directed inwardly to open channel or grilling slot 103.

A circuit 116 or circuit mechanism or means is positioned within main body unit 102 as shown and is electrically connected with switch mechanism 116C, supply wire 121, a switch wire 116B, and a connective wire 116A. Switch wire 116B provides an electrical connection between circuit 116 and at least one of switch mechanism 116C, power cord 121, heating elements 122, and engaging means/safety means 109. During use, where engaging means 109 is used, depression or activation of engaging means 109 provides an electric signal along switch wire 116B to control circuit 116. Connective wire 116A joins control circuit 116 with heating elements 122 as shown. Connective wire 116A may connect with heating elements in series or in parallel depending upon alternative circuit designs.

In the various circuit embodiments discussed above, circuit 116 may be or may include an automatic shut-off circuit control, a timing device, or alternative circuits well known in the art without departing from the scope and spirit of the present invention. Circuit 116 may additionally include various electrical components including transformers for current control, and resistors and capacitors for user safety.

Heating elements 122, are positioned on opposing sides of channel 3 as shown. Heating elements 122 each include short surfaces 122C and long surfaces 122B, although alternative embodiments may provide single or multiple surfaces depending upon design.

In the present embodiment, heating elements 122 consists of a nichrome wire heating element 122D supported by a thermally and electrically resistive support member 122E, for example a mica board or electrical insulation coated metal support. Each support member 122E includes short and long surfaces 122C, 122B.

As shown, the long surface or portion 122D projects upwards from bottom member 111 and short surface 122C projects outward from a side member 112. Tabs 122A, projecting from outer sides of short and long surfaces 122C, 122B, engage slots (not shown) and fixably position heating elements 122 relative to open channel 103 and guard 104.

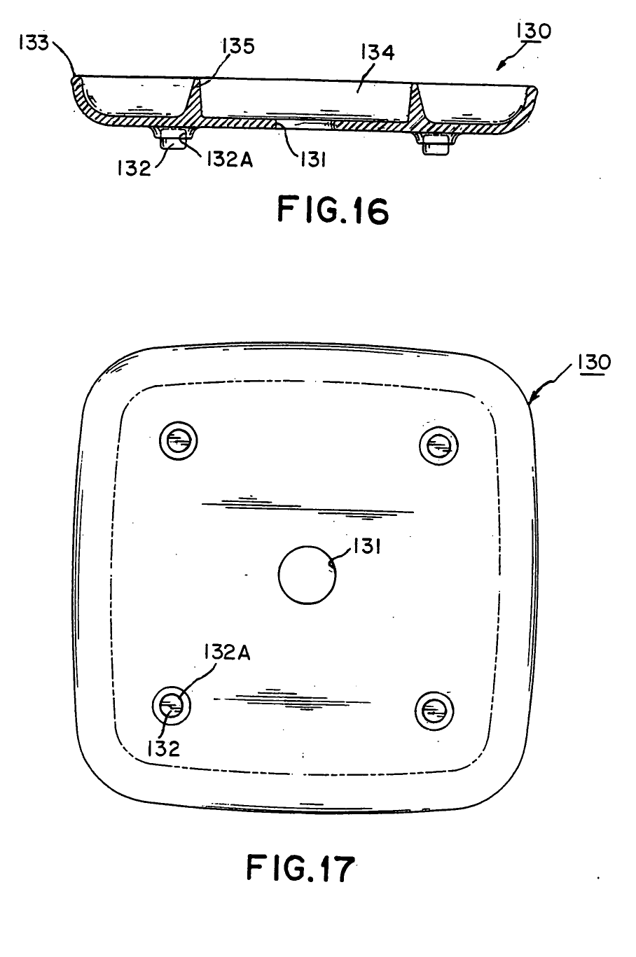

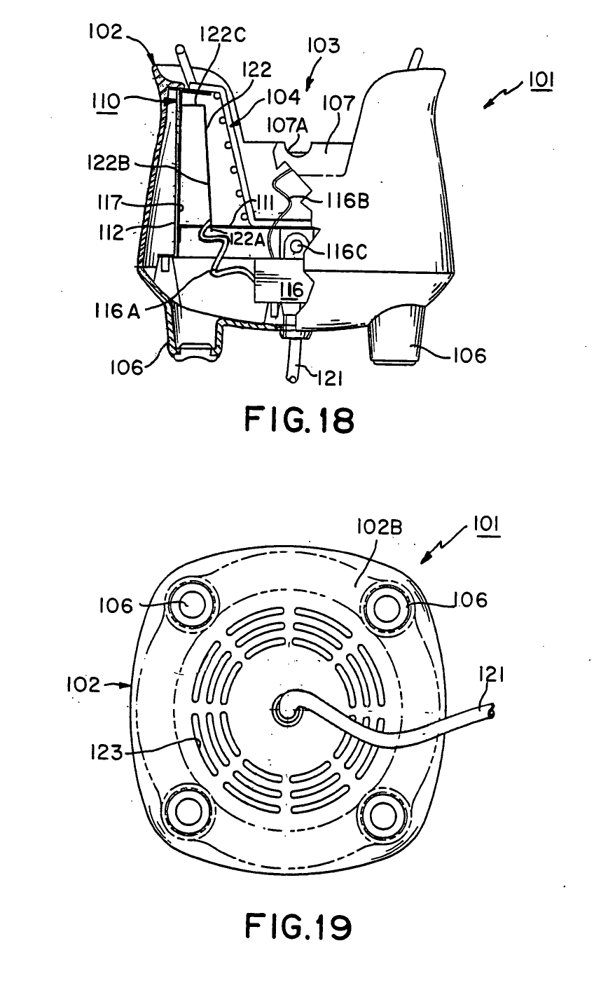

Referring now to FIG. 19, the bottom of bottom shell 102B includes a plurality of vents 123 arranged circumferentially relative to grommet 124, as shown. Vents 123 provide thermal transfer access to the internal structure of main body unit 102, support assembly 110 and heating elements 122. Vents 123 allow for both the entry of upward-flowing cooling and transport air (and hence passage upward past heating elements 122 for exit from channel 103) and the exit of downward-flowing hot air (and hence hot air exit from the bottom of body unit 102.

While those skilled in the art of thermodynamic analysis will readily recognize that warm air flows upward in the Earth's gravity well, the present invention additionally envisions the use of one or more electrical cooling fans, to limit or prevent unit over heating, positioned proximate vents 123 and inducing a forced air current in either direction. It will also be recognized that vents 123 may be alternatively positioned or designed without departing from the scope and spirit of the present invention.

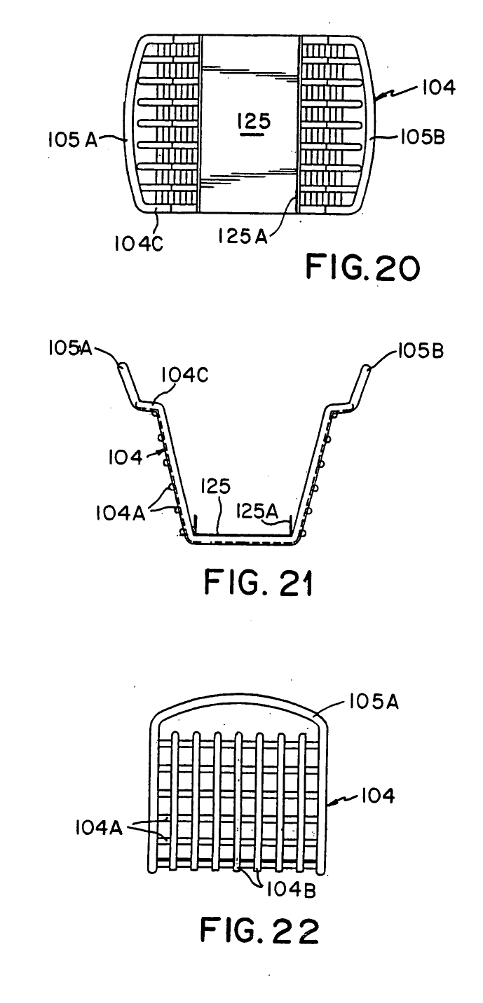

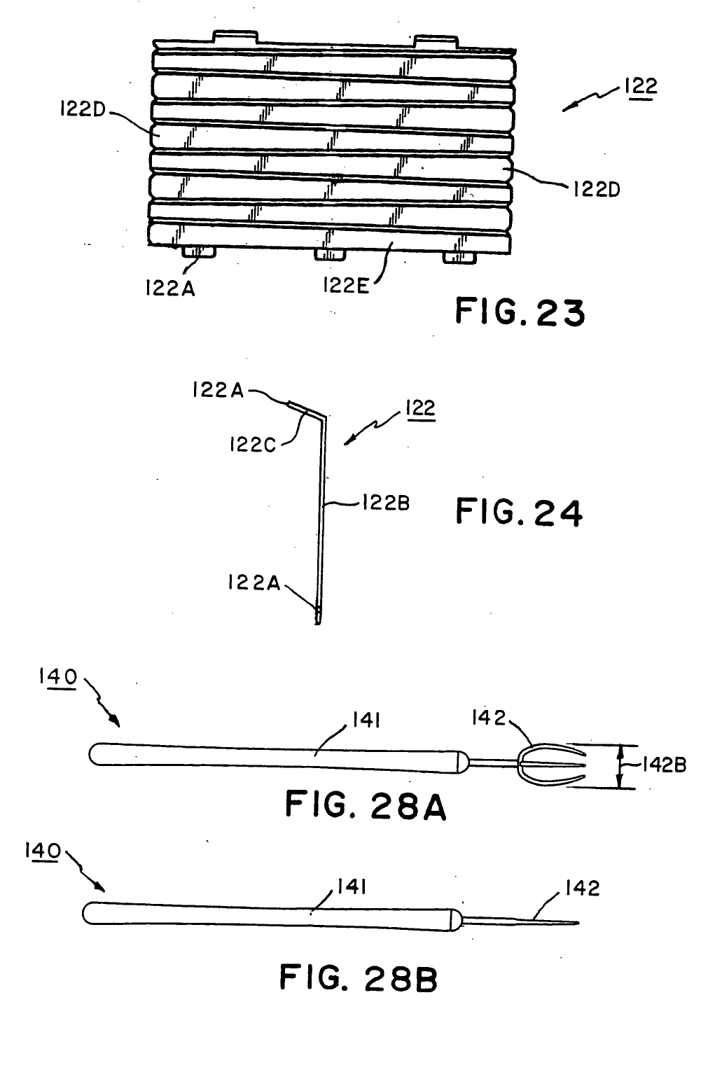

Referring now to FIGS. 20 through 24 it is noted that tabs 122A, projecting from outward from heating element 122 and support member 122E, are shaped in a three-sided form simple to manufacture. Alternative shapes and constructions for tabs 122A and support members 122E are envisioned for the present invention allowing for ready adaptation to multiple manufacturing processes.

It is also noted, that as discussed in the previous embodiment, the construction of heating elements 122 and bench top grill 101 provides for thermal focusing within grilling channel 103. In the present embodiment, heating elements 122 are shown tilted, at a preselected angle relative to the vertical, and in use operate to project thermal energy inwardly to channel 103. It is further envisioned in the present embodiment that portions of heating elements 122 may be shaped in a concave or other curved or angular manner (similar to those described above) to additionally focus energy toward a central region within channel 103. In this manner, both embodiments enable adaptation to a variety of either uniform of focused thermal uses while maintaining simple construction.

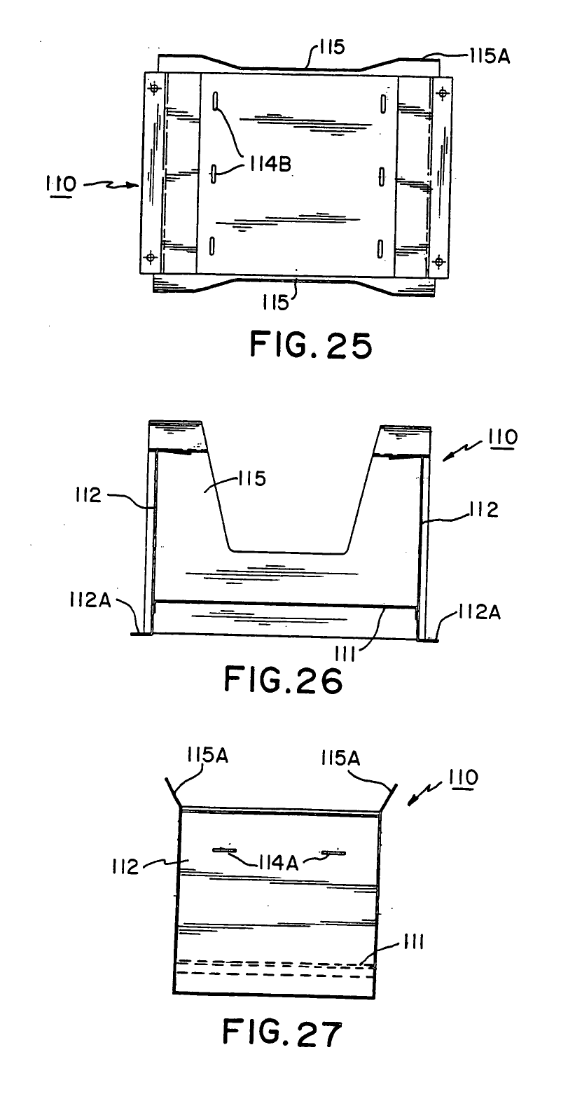

Referring now to FIGS. 25 through 27, support bracket assembly or support means 110 is shown including side members 112, 112 with corresponding small leg portions 112A, 112A Bottom member 111 extends between corresponding side members 112, 112, as shown. A plurality of slots 114B formed on bottom member 111 are shaped to receive corresponding tab portions 122A extending from the long surface 122B of heating element 112. A plurality of slots 114A are formed on upright side members 112 and correspond to and are shaped to receive tab portions 122A extending from the short surfaces 122C of heating elements 122.

During assembly, tabs 122A are positioned within respective slots 144A, 144B and secure heating elements 122 relative to open channel 103 and bottom member 111. It will be recognized by those skilled in the art that the shape and form of the slots and tabs may be readily adapted for a variety of needs without departing from the scope and goal of the present invention. For example, concave or other shapes for heating elements 122 may be required thereby enabling ready adaption to alternative thermal focusing designs allowing the maximization of thermal energy along open channel 103, or at a selected location within grilling channel 103.

An alternative embodiment for assembly 110 includes a plurality of engaging tabs (not shown) extending outwardly from portions of assembly 110 and engaging an inner surface or corresponding inner slots of the outer shell to ensure a secure position. While the engaging tabs (not shown) are discussed, alternative means for engaging and securing assembly 110 within the housing during a manufacture are well known within the consumer equipment market and are intended to be incorporated herein.

A set of opposing side guards 115, 115 extend between side members 112, 112 and include shapes adaptable to open channel 103. Side guards 115 aid in the stiffening of support bracket assembly 110 and its position and stability within main body unit 102. Upper portions of side guards 115 extend as bent end guards 115A, 115A. Guards 115A rest proximate the top rim 102C of body shell 102A as shown.

Those skilled in the art will note the generally rounded-corner square shape for main body unit 102 (see FIG. 11) and should understand that the outer shape of the present alternative embodiment may be readily adapted to alternative forms, including round or extended rectangular forms having one side longer than an adjoining side. Corresponding and adaptive modifications to meet a new shape may be readily and easily made to support bracket assembly 110, guard 104, heating elements 122 and other items noted above without departing from the spirit and scope of the present invention.

Referring now to FIGS. 28A and 28B, an alternative embodiment for a utensil 140 is shown. Utensil 140 includes a handle 141, and tines 142 having a maximum width 142B. As discussed above, width 142B is larger than a corresponding opening size in guard 104 and correspondingly provides an additional safety feature, preventing users from inserting the tines and contacting heating elements 122, 122.

Another alternative embodiment of the present invention additionally envisions a timing unit and/or a temperature/grilling control (not shown) within main body unit 2, 102 without a utensil sensing means. The timing unit may be similar to those conventionally known in the art of toasting or grilling timer design. The temperature/grilling control may be some form of electrical control unit allowing a user to select the current (or gas volume) supplied to heating elements 11, thereby allowing either a slow grilling action or a faster grilling action. Another alternative embodiment may allow a user to selectively use one or both sides of a heating elements 11, 122 during grilling (for example where there are two parallel channels 3, 103 in bench top grill 1, 101, the central heating element may be used for both channels. In this manner, the present invention provides maximum user control over the grilling action and may easily achieve the desired result.

As discussed earlier, where grilling or open channel 3,103 has an alternative configuration, i.e. close-ended opening (bench top grill 1′), there may be additional heating elements provided on the third (non horizontal) side thereby preserving or increasing many of the benefits noted above for the present invention. Alternatively, where desired by a manufacturer an additional heating unit may be positioned below the item to be grilled, thereby enabling a two, three, or even four-sided grilling while preserving many of the benefits noted herein for the present invention.

As noted above, it should be understood that open channels 3, 3′, 3″, and 103 may also be referred to as defining grilling zones, optionally including and generally defining a directed heating foci or nexus area (formed by concave or shaped heating elements 11, 122 and supports 12, 110 focusing thermal energy toward a selected center point, range, area, or zone within the open channel) to effectuate a speedier and quick grilling than achievable with flat heating elements.

As also noted, above, while the present invention generally envisions no grilling or heating element positioned below the item to be grilled solely to avoid the inconvenience of cleaning drippings or crumbs on a heating element.

An alternative embodiment of the present invention clearly envisions and allows designs where grilling or open channel 3, 103 is three sided (see FIG. 2A i.e. 4 sides including the bottom side), or even where open channel 3, 103; is positioned as in FIG. 1. The possible placement of an additional heating element 11, 122 on the third, fourth, or bottom sides of channel 3, 103 provides a three-sided grilling effect to an item to be grilled.

As a consequence of the present design, and the embodiments envisioned, the present invention provides an easily controlled asymmetric or symmetric grilling result depending upon a user's desires.

As noted above, heating elements may be at least one of an electrical resistive element, a combustion gas (natural gas, propane, butane etc.), a photonic-based element (strong light i.e. arc light generated heat), and a combination of any of those capable of providing the function of transmitting a grilling heat to an item to be grilled.

In the claims, means- or step-plus-function clauses are intended to cover the structures described or suggested herein as performing the recited function and not only structural equivalents but also equivalent structures.

Although only a single or a few exemplary embodiments of this invention have been described in detail above, those skilled in the art will readily appreciate that many modifications are possible based upon the exemplary embodiment(s) without materially departing from the novel scope, teachings, and advantages of this invention. Accordingly, all such modifications are intended to be included within the spirit and scope of this invention as defined in the appended claims.

1. A bench top grill assembly, comprising:
a grilling channel;
heat source means for generating at grilling energy on at least two sides of sides of said grilling channel;
means for providing a lateral access to said heat source so that an item to be grilled may be introduced through at least one lateral end of said grilling channel; and
said heat source means including control circuit safety means for controlling an electrical energy supply to said heat source means, whereby during a use of said assembly a utensil introducing said item to be grilled is sensed engages said safety means and enables or disables a grilling.

2. A bench top grill assembly, according to claim 1, wherein:
said control circuit safety means includes at least one of a timing circuit, an arc-fault detector, a temperature selector, a tilt-detector, and a means for activating said heat source means upon said insertion of said item to be grilled into said grilling channel, and a means for deactivating said heat source means upon a removal of said item to be grilled, whereby user safety is increased.

3. A bench top grill assembly, according to claim 2, further comprising:
a support table spacing at least said grill body from an external work surface;
said support table is at least one of a rotatable support and a fixed support;
at least one recess on a surface of said support table; and
said at least one recess shaped to receive at least one of said bench top grill, a grilling utensil, a condiment, a condiment assembly, and at least one condiment container, whereby said at least one recess minimizes a shifting of said one relative to said surface during said use and a transport thereby increasing a convenience and a safety of said bench top grill kit.

4. A bench top grill kit, comprising:
a grilling channel in a grill body;
heat source means in said grill body for generating at grilling energy on opposing sides of said grilling channel;
means for providing a lateral access to said heat source so that an item to be grilled may be introduced through at least one lateral end of said grilling channel;
a support table spacing at least said grill body from an external work surface;
said support table is at least one of a rotatable support and a fixed support;
a grilling utensil for holding said item within said grilling channel to receive said grilling energy on opposing sides; and
guard means for providing a divided access between said grilling channel and said heat source means, whereby said guard means allows said grilling energy to be directed inwardly to said grilling channel while preventing a tool end of said grilling utensil access to said heat source means.

5. A bench top grill kit, according to claim 4, wherein:
said heat source means includes at least a circuit means for supplying an electrical current to said heat source means.

6. A bench top grill kit, according to claim 5, further comprising:
safety means for sensing and activating said heat source means upon a lateral insertion of said item to be grilled in said grilling channel and for sensing and deactivating said heat source means upon a removal of said item to be grilled, whereby user safety is increased.

7. A bench top grill kit, according to claim 6, wherein:
said circuit means includes at least one of a timer, a temperature indicator, an operation indicator, an arc-fault detector, and a tilt detector.

8. A bench top grill, comprising:
a main body unit defining at least a first grilling channel;
at least two surfaces bounding said grilling channel;
at least two of said at least two surfaces opposing each other;
at least two heating elements proximate respective said at least two bounding surfaces providing a grilling thermal energy inwardly to said at least first grilling channel during a use;
means for providing a lateral access to said grilling surfaces so that an item to be grilled can be introduced through one lateral end to be positioned proximate said heating elements;
means for detecting an insertion of an items to be to be grilled into said grilling channel and for detecting a removal of said item from said grilling channel; and
said means for detecting including means for actuating at least one of said heating elements upon a detection of said insertion of said item to be grilled thereby enabling said item to be grilled, and for deactivating said at least one of said heating elements upon said removal of said item from said grilling channel thereby providing a safe deactivation of said bench top grill.

9. A bench top grill, according to claim 8, wherein:
said means for detecting includes at least one of a pressure contact switch, an optical detecting switch, a grilling channel insertion guard inhibiting said lateral access, and a pivotable contact switch actuating upon a contact from said item to be grilled.

10. A bench top grill, according to claim 8, wherein:
said at least two surfaces being positioned vertically relative to an external support surface for said bench top grill.

11. A bench top grill, according to claim 10, wherein:
said means for providing a lateral access includes at least one lateral opening in said grilling channel, whereby said means for providing enables at least a single sided user access.

12. A bench top grill, according to claim 10, wherein:
said means for providing a lateral access includes at least two opposing lateral openings in said grilling channel, wherein said means for providing enables at least a two-sided user access to said grilling channel.

13. A bench top grill, according to claim 8, wherein:
said at least two heating elements including at least one of an electrically resistive element, a combustion gas element, and a photonic-based element.

14. A bench top grill, according to claim 8, further comprising:
at least a first and a second safety guard;
each said safety guard being at least one of a removable and a non-removable guard; and
each said safety guard spacing respective ones of heating elements from said grilling channel, whereby said safety guards enable an increased safety of said bench top grill.

15. A bench top grill, according to claim 14, further comprising:
at least a first bottom surface of said grilling channel;
said bottom surface being perpendicular to at least one of said at least two heating elements; and
said bottom surface including at least one of a non-porous surface, a non-stick coated surface, a recessed dripping-catch-zone, and a dish washer safe surface.

16. A bench top grill, according to claim 14, further comprising:
at least a first utensil support; and
said at least first utensil support being at least one of a removable and a non-removable utensil support.

17. A bench top grill, according to claim 16, wherein:
said means for detecting includes at least one of a pressure contact switch, an optical detecting switch, a grilling channel insertion guard inhibiting said lateral access, and a pivotable contact switch actuating upon a contact from said item to be grilled.

18. A bench top grill, according to claim 17, wherein:
said means for detecting includes said pressure contact switch; and
said means for detecting and said means for actuating includes said utensil support positioned engagably with said pressure contact switch, whereby during said use said means for providing lateral access enables a user to position said item to be grilled and an item-supporting utensil on said utensil support thereby engaging said means for detecting and said means for actuating and enabling said item to be grilled.

19. An bench top grill, comprising:
a main body unit including at least a first grilling channel;
said at least first grilling channel bounded on at least three sides;
at least one of said three sides being a vertical side relative to an external main body unit support surface and said at least one side opposing at least one of said two remaining sides of said grilling channel;
a first and a second heating element;
at least one of said heating elements being proximate said vertical side; and
each said heating element projecting a grilling thermal energy into said grilling channel during a use, whereby an item-to-be grilled positioned within said grilling channel by a user receives said grilling thermal energy from two directions during said use.

20. A bench top grill, according to claim 19, further comprising:
a first and a second safety guard;
each said safety guard spacing said grilling channel from respective said heating elements; and
respective said safety guards permitting a transmission of said thermal energy from respective said heating element into said grilling channel while prohibiting a user access or a food-item access to said heating elements, thereby increasing a user safety of said bench top grill.

21. A bench top grill, according to claim 19, wherein:
said grilling channel is a channel transverse to said main body unit allowing a three sided user access to said grilling channel, thereby providing a convenient duel-sided user access to said bench top grill.

22. A bench top grill, according to claim 21, further comprising:
means for enabling a removal and a secure reinstallation of respective said safety guards; and
said means for enabling including at least a grasping means on respective said safety guards for facilitating a secure user-grip during a removal and a reinstallation, whereby said guards are easily cleaned after each use and a user convenience is increased.

23. A bench top grill, according to claim 20, further comprising:
a non-stick coating on each said safety guard, thereby facilitating quick and easy cleaning of said safety guards after said use.

24. A bench top grill, according to claim 20, wherein:
each respective said safety guard is a wire grid guard, whereby respective said wire grid guards provide a divided access to respective said heating elements thereby improving a user safety while permitting a user to visually confirm heating element operation.

25. A bench top grill, according to claim 19, wherein:
respective ones of said heating elements are at least one of an electrically resistive-based heating element, a combustion-based heating element, a photonic-based element, and a combination of selected ones of the same; and
said bench top grill includes at least one energy control circuit means for controllably supplying an energy supply to said heating elements during said use, thereby improving user safety of said bench top grill.

26. A bench top grill, according to claim 25, further comprising:
at least a first means for switchably controlling an operation of said energy control circuit means, whereby said means for switchably controlling enables an activation and a deactivation of said energy control means, thereby increasing a user and a grill safety.

27. A bench top grill, according to claim 26, wherein:
said means for switchable controlling includes a user engagement means for engaging said means for controlling and said energy control circuit upon a user-insertion of said item-to-be grilled into said grilling channel, and for disengaging said means for controlling and said energy control circuit upon a user-removal of said item to-be-grilled from said grilling channel.

28. A bench top grill, according to claim 26, wherein:
said means for switchably controlling includes at least one of a timer circuit, a pressure contact circuit, a photo sensor circuit, and an on-off switch.

29. A bench top grill, according to claim 26, further comprising:
at least one utensil support in said bench top grill; and
said utensil support being at least one of a removable and a non-removable utensil support.

30. A bench top grill, according to claim 29, wherein:
said utensil support is proximate at least a first end of said grilling channel;
a pressure contact switch in said means for switchably controlling; and
said utensil support engaging said pressure contact switch upon receiving a user utensil in said grilling channel during said use and disengaging said pressure contact switch upon a removal of said user utensil from said grilling channel, whereby said use triggers said contact switch and said means for switchably controlling thereby increasing a user safety and convenience.

31. A bench top grill, according to claim 19, further comprising:
at least a first bottom surface defining a bottom of said grilling channel;
said first bottom surface perpendicular to each said vertical side; and
said first bottom surface being at least one of a smooth surface, a non-stick surface, a recessed dripping catch zone, and a dishwasher safe surface.

32. A bench top grill, according to claim 31, further comprising:
a removable drip-catching container;
said bottom surface supporting said removable drip-catching container proximate said bottom of said grilling channel, whereby said container is easily removed by a user for cleaning improving a user convenience of said bench top grill.

33. A bench top grill, according to claim 19, further comprising:
a first and a second safety guard providing a divided access to said heating elements, each said safety guard spacing said grilling channel from respective said heating elements; and
said grilling channel shaped to allow a multiple user access to said grilling channel, thereby providing a convenient optional user access to said bench top grill.

34. A bench top grill, according to claim 33, further comprising:
at least a first and a second utensil rest operably positioned on opposing sides of said grilling channel.

35. A bench to grill, according to claim 34, further comprising:
at least one electronic control circuit supplying an electric current to said heating elements during said use; and
at least one pressure sensing switch in said control circuit, whereby when said switch is activated, said circuit is completed and said heating elements operate to grill a food item placed within said at least first grilling channel.

36. A bench top grill, according to claim 35, wherein:
at least one of said at least first and second utensil rests activating said at least one pressure sensing switch when receiving a weight of a user's utensil and activating said heating elements and deactivating said pressure sensing switch when said utensil is removed, thereby increasing a user safety of said bench top grill.

37. An bench top grill, according to claim 19, wherein:
each said heating element has a concave shape relative to respective said sides; and
said opposing concave shaped heating elements forming a heating center nexus zone proximate a mid-region of said grilling channel, whereby a thermal energy distribution in said grilling channel is concentrated in said nexus zone enabling a faster grilling in said zone during a use and increasing a user satisfaction.

38. A bench top grill, according to claim 37, wherein:
each said heating element includes at least one nichrome wire element supported by an electrically insulated member.

39. A bench top grill, comprising:
a main body unit defining at least a first open grilling channel;
said grilling channel bounded on at least three sides by said main body unit;
said at least three sides including at least a one vertical side relative to a grill support surface;
guard means for spacing a respective heating element from respective sides of said grilling channel; and
said at least two of said respective sides of said grilling channel being ones of respective parallel sides and adjoining sides, whereby during a use, said heating elements operate to grill an item-to-be grilled positioned within said grilling channel along at least two sides.

40. A bench top grill, according to claim 39, further comprising:
at least one control circuit providing an energy supply to said heating elements; and
said heating elements having at least one of a planar and a non-planar shape;

41. A bench top grill, according to claim 40, wherein:
said heating elements have a non-planar convex shape relative to said grilling channel, whereby said non-planar shapes generate a grilling zone within said grilling channel during said use, thereby generating a grilling temperature spectrum within said grilling channel enabling a user to select a preferred grilling temperature during said use.

42. A bench top grill, according to claim 41, further comprising:
at least one pressure contact switch in said at least one control circuit;
at least one utensil support proximate said grilling channel;
said utensil support transmitting a user-utensil support pressure to said pressure contact switch during said use, whereby said user connects said control circuit with said support pressure and activates a safe grilling of an item positioned within said grilling channel.

43. A bench top grill, comprising:
a main body unit;
said main body unit defining at least a first grilling channel;
at least a first and a second side of said channel projecting upwardly in said grilling channel relative to an external grill support surface;
a first and a second grilling element;
means for removably positioning a guard grill in said channel and spacing said grilling channel from said first and second grilling elements; and
said at least first and second grilling elements positioned in at least one of opposing parallel positions and perpendicularly adjoining positions, whereby an item being grilled receives thermal energy from at least two directions during a use.

44. A bench top grill, according to claim 43, further comprising:
means for engaging and disengaging an operation of said grilling elements during said use; and
said means for engaging and disengaging including at least one of a user support, an optical grilling utensil detector, a circuit control switch, a pressure sense switch, and a timer switch, whereby during said use, said means for engaging and disengaging increases a user safety during a bench top grill use.

45. A bench top grill kit, comprising:
a bench top grill and at least one utensil;
said bench top grill further comprising:
a main body unit defining at least a first grilling channel;
said first grilling channel having at least a first and second opposing side;
at least a first and a second heating element in said grilling channel proximate respective said opposing sides;
means for providing a lateral access to said heating elements so that an item to be grilled may be introduced through at least one lateral end of said first grilling channel and positioned proximate said heating elements; and
said first and second sides of said grilling channel being one of respective parallel sides and adjoining sides.

46. A bench top grill kit, according to claim 45, further comprising:
guard means for spacing said heating elements from said first grilling channel, whereby a safety of said bench top grill kit is improved.

47. A bench top grill kit, according to claim 46, wherein:
said guard means includes at least one of a pair of opposing guard members and a continuous guard member;
each said wire grid guard members having a first wire grid size;
a gripping end and a tool end on said at least one utensil; and
said tool end being at least one of a single-pronged end, a multi-pronged end, a basket container end, a toothed gripping end, whereby a user may grill a plurality of food items safely within said channel and increase a utility of said grill kit.

48. A bench to grill kit, according to claim 47, wherein:
said tool end is said multi-pronged end having an outer width dimension; and
said outer width dimension is greater than said first wire grid size, whereby said guard means prevents said tool end from contacting respective said heating elements, and a user safety and a grill durability are increased.

49. A bench top grill assembly, comprising:
a grilling channel;
heat source means for generating at grilling energy on opposing sides of said grilling channel;
means for providing a lateral access to said heat source so that an item to be grilled may be introduced through at least one lateral end of said grilling channel;
a support table spacing at least said grill body from an external work surface;
said support table is at least one of a rotatable support and a fixed support;
at least one recess on a surface of said support table; and
said at least one recess shaped to positionably receive at least one of said bench top grill, a grilling utensil, a condiment, a condiment assembly, and at least one condiment container, whereby said at least one recess minimizes a shifting of said one relative to said surface during said use and a transport thereby increasing a convenience and a safety of said bench top grill kit.

50. A bench top grill assembly, according to claim 49, further comprising:
at least one utensil for positioning said item to be grilled in said grilling channel; and
said heat source means including control circuit safety means for activating said heat source means upon said insertion of said item to be grilled into said grilling channel and for deactivating said heat source means upon a removal of said item to be grilled, whereby user safety is increased.
